(19) United States
(12) Patent Application Publication
(10) Pub. No.: US 2024/0377333 A1
(43) Pub. Date: Nov. 14, 2024

(54) NOBLE METAL-CONTAINING COMPOUND DETECTION BY CATALYSIS OF OPTICAL DYE REDUCTION

(71) Applicant: Becton, Dickinson and Company, Franklin Lakes, NJ (US)

(72) Inventors: Melody Mei Hee Kuroda, Durham, NC (US); Joseph Thomas, Cary, NC (US); David Sebba, Lutherville-Timonium, MD (US); Alexander G. Lastovich, Gilbert, AZ (US)

(21) Appl. No.: 18/316,148

(22) Filed: May 11, 2023

(51) Int. Cl. G01N 21/64; G01N 1/02; G01N 21/84

(52) U.S. Cl. CPC G01N 21/8483; G01N 1/02; G01N 21/31; G01N 2001/028

(57) ABSTRACT

Methods, kits and devices for detecting noble metal-containing compound contamination of a surface are provided according to aspects of the present disclosure. According to aspects of the invention, methods for detecting noble metal-containing compound contamination of a surface include collecting a sample comprising a noble metal-containing compound from said surface; contacting said sample with a dye and a reducing agent to form a test solution; and measuring an absorbance of the test solution.

### BACKGROUND

### Field

The present disclosure relates to methods and systems for environmental contaminant testing, and more particularly, to methods for detecting the presence and/or quantity of hazardous noble metal-containing compounds, including antineoplastic agents.

### Description of the Related Art

Antineoplastic agents are used to treat cancer by affecting the process of cell division. Noble metal-containing antineoplastic agents are particularly common and include drugs such as cisplatin, carboplatin, oxaliplatin, and nedaplatin. Almost 50% of patients receiving chemotherapy receive platinum-based antineoplastic agents. Antineoplastic agents are highly toxic and can also affect healthy cells and tissue. The most common effects from exposure to antineoplastic agents include damage to the bone marrow, skin, and the inner lining of the gastrointestinal tract. Accordingly, detection of antineoplastic drugs is critical for determining if there is contamination/leakage in hospital/pharmacy areas where the drugs are used and/or dispensed.

Due to their high toxicity and widespread usage, precautions should be taken to eliminate or reduce occupational exposure to antineoplastic agents for healthcare workers. Pharmacists who prepare these drugs and nurses who may prepare and administer them are the two occupational groups who have the highest potential exposure to antineoplastic agents. Additionally, physicians and operating room personnel may also be exposed through the treatment of patients. Hospital staff, such as shipping and receiving personnel, custodial workers, laundry workers and waste handlers, all have the potential to be exposed to these drugs during the course of their work. The increased use of antineoplastic agents in veterinary oncology also puts these workers at risk for exposure to these drugs.

Currently, the most common method for detecting noble metal-containing compounds is mass spectrometry. However, this method often involves sending samples from the place of collection to a centralized testing location with validated methods. This results in significant delay between sample collection and results and a high cost per sample. Thus, a need exists for a safe, effective, and convenient method for detecting contamination by antineoplastic agents, particularly antineoplastic agents containing noble metals.

### SUMMARY

In some embodiments, provided herein is a method for detecting noble metal-containing compound contamination of a surface, the method comprising: collecting a sample comprising a noble metal-containing compound from said surface; contacting said sample with a dye and a reducing agent to form a test solution; and measuring an absorbance of the test solution.

In some embodiments the method may further comprise measuring the rate of absorbance change.

In some embodiments, the dye may be an azo dye. In some specific embodiments, the dye may be Congo red or methyl orange. In other embodiments, wherein the dye may be methylene blue.

In some embodiments, the reducing agent may be selected from the group consisting of: lithium borohydride, lithium aminoborohydride, sodium borohydride, and sodium cyanoborohydride. In some specific embodiments, the reducing agent may be sodium borohydride.

In some embodiments, the noble metal may be selected from the group consisting of ruthenium, rhodium, palladium, platinum, silver, gold, osmium, and iridium. In some embodiments, the noble metal is platinum. In some specific embodiments, the noble metal-containing compound may be selected from the group consisting of: cisplatin, oxaliplatin, nedaplatin, carboplatin, triplatin tetranitrate, phenanthriplatin, picoplatin, and satraplatin. In other embodiments, the noble metal may be ruthenium. In some specific embodiments, the noble metal-containing compound may be sodium trans-imidazoledimethylsulfoxidetetrachlororuthenate(III), imidazolium trans-imidazoledimethylsulfoxidetetrachlororuthenate(III), or sodium trans-[tetrachloridobis(1H-indazole)ruthenate(III)]. In yet other embodiments, the noble metal may be gold. In some specific embodiments, the noble metal-containing compound may be selected from the group consisting of: gold sodium thiosulfate, gold sodium thiomalate, disodium aurothiomalate, aurothioglucose, and auranofin.

In some embodiments, the absorbance of the test solution may be measured between 490 nm and 510 nm. In other embodiments, the absorbance may be measured between 460 nm and 480 nm. In yet other embodiments, the absorbance may be measured between 660 nm and 680 nm.

In some embodiments provided herein is a noble metal-containing compound contamination detection system comprising: a collection device comprising: a liquid configured to lift a noble metal-containing compound contaminant from a test surface when the liquid is applied to the test surface, an absorbent swab material configured to absorb at least a portion of the liquid and to contact the test surface to collect the noble metal-containing compound contaminant; a handle having a first end coupled to the absorbent swab material, a second end spaced apart from the first end, and an elongate length extending therebetween; a liquid-tight container having an interior volume dimensioned to encase the handle and the absorbent swab material and the liquid, the container having a nozzle including an orifice sized to provide controlled release of a volume of the liquid from the interior volume; and a detection device comprising: a test cartridge positioned to receive the volume of the liquid released from the container, the test cartridge comprising a dye and a reducing agent to produce an optically-detectable change in appearance in the presence of the noble metal-containing compound contaminant, and an image sensor positioned to receive light reflected from the test cartridge and configured to generate signals representing an intensity of the received light, and control electronics configured to analyze the signals and determine the presence of the noble metal-containing compound contaminant in the test cartridge.

In some embodiments, the noble metal-containing compound contamination test system described herein may further comprise a demarcation guide specifying an area of the test surface to be tested for contamination by the noble metal-containing compound contaminant. In some embodiments, the noble metal-containing compound contamination test system provided herein, the control electronics may be configured to determine whether the noble metal-containing compound contaminant is in contact with the contents of the test cartridge based at least partly on the intensity of the signals and the area of the test surface.

In some embodiments, the container may comprise: an open end having an aperture into the interior volume; and a releasable portion of the container including: an attachment mechanism configured to releasably couple to the container over the open end to provide a liquid-tight seal with the interior volume of the container with the handle and the absorbent swab material and the liquid sealed within the interior volume, the nozzle, and a cap releasably coupled to the nozzle.

In some embodiments, the handle may have a first T-shaped cross section, and wherein the interior volume of the container may have a second T-shaped cross section sized to receive the first T-shaped cross section of the handle.

In some embodiments, at least a portion of the container may be flexible such that the interior volume can be compressed to expel the volume of the solution from the interior volume through the orifice of the nozzle.

In some embodiments, the detection device may comprise a network connection interface, and wherein the control electronics are configured to send data representing whether the noble metal-containing compound contaminant is in contact with the dye and the reducing agent to at least one remote computing device over a network via the network interface.

In other embodiments provided herein is a noble metal-containing compound contaminant collection device comprising: a liquid-tight container having an interior volume and containing a dye and a reducing agent; a liquid configured to lift a hazardous noble metal-containing compound contaminant from a test surface when applied to the test surface; an absorbent swab material configured to absorb at least some of the liquid and to contact the test surface to collect the hazardous noble metal-containing compound contaminant; and a handle having a first end coupled to the absorbent swab material, a second end spaced apart from the first end, and an elongate length extending therebetween, wherein the interior volume is dimensioned to contain the handle and absorbent swab material and the at least some of the liquid, the container having a nozzle including an orifice sized to provide controlled release of a volume of the liquid from the interior volume.

In some embodiments, the container may comprise an open end having an aperture into the interior volume; and a releasable portion of the container including: an attachment mechanism configured to releasably couple to the container over the open end to provide a liquid-tight seal with the interior volume of the container with the handle and absorbent swab material and liquid sealed within the interior volume, the nozzle, and a cap releasably coupled to the nozzle.

In some embodiments, the attachment mechanism may comprise threading along an interior surface of the releasable portion, and wherein the open end of the container comprises corresponding threading along an exterior surface of the open end.

In some embodiments, the handle may comprise a T-shaped cross section defining: a swab holding member having a flat first surface and a second surface spaced apart from the first surface, and a handle portion extending away from the second surface.

In some embodiments, the absorbent swab material comprises two layers of fabric coupled to the first surface of the flat swab holding member. In some embodiments, a width of the absorbent swab material may be greater than a width of the flat first surface swab holding member. In some embodiments, the absorbent swab material may be coupled to the flat first surface of the swab holding member at opposing edges of the swab material with a gap between a central portion of the absorbent swab material and the flat first surface of the swab holding member.

In some embodiments, the interior volume of the container may have a T-shaped cross section corresponding to the T-shaped cross section of the handle.

In some embodiments, the nozzle may comprise a channel leading to the orifice, wherein a cross-section of the channel is shaped to release the volume of the liquid one drop at a time.

Also provided herein is a method of testing a test surface for the presence of a hazardous noble metal-containing compound contaminant, the method comprising: removing an absorbent swab material coupled to an elongate handle from liquid-tight packaging, the absorbent swab material pre-moistened with a first volume of a liquid configured to lift the hazardous contaminant from the test surface, wherein the absorbent swab material is impregnated with the first volume of the liquid; wiping the test surface with the absorbent swab material to collect particles of the hazardous contaminant from the test surface; inserting the absorbent swab material into an open end of a liquid-tight container, the liquid-tight container comprising a well containing a second volume of the liquid and a cap to seal the well; sealing the liquid-tight container with the cap to isolate the first and second volumes of the liquid within the liquid-tight container; agitating the liquid-tight container to release at least some of the collected particles of the hazardous contaminant into the liquid; opening a sealable orifice of the cap; transferring a third volume of the liquid from the liquid-tight container to a cartridge comprising a dye and a reducing agent through the sealable orifice; inserting the cartridge into a cartridge reader device; and based on an output of the cartridge reader device, identifying that the noble metal-containing compound contaminant is present on the test surface.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A illustrates an example of an open system contaminant collection device and open system detection device.

FIGS. 1B-1D illustrate various views of an example handle of the collection device of FIG. 1A.

FIG. 1E illustrates an example collection container of the collection device of FIG. 1A.

FIGS. 1F-1G illustrate various views of an example snap fit removable top of the collection device of FIG. 1A.

FIG. 1H illustrates an example of the detents discussed with respect to FIGS. 1F-1G in a threaded embodiment of an example removable top.

FIGS. 1I through 1K illustrate various views of the handle of FIGS. 1B-1D positioned within the collection container of FIG. 1E.

FIG. 1L illustrates a cross-sectional view of an example removable cap of the collection device of FIG. 1A.

FIGS. 1M-1O illustrate various views and components of a collection kit.

FIG. 1P illustrates an example stability foot that can be used with the collection container of FIG. 1E.

FIG. 2 illustrates another example of an open system contaminant collection device.

FIGS. 3A and 3B illustrates example steps of a testing method using an open system contaminant collection device.

FIG. 4 illustrates an example of a closed system contaminant collection device.

FIGS. 5A-5D illustrate another example of a closed system contaminant collection device and an example of a closed system detection device.

FIG. 6 illustrates example steps of a testing method using a closed system contaminant collection device.

FIGS. 7A and 7B illustrate an example testing device.

FIG. 8 depicts a high level schematic block diagram of an example testing device.

FIGS. 9A and 9B illustrate another example of a contaminant collection device.

FIGS. 10A-10B illustrate another example of a contaminant collection device.

FIG. 11 illustrates an example of a pivoting collection device swab.

FIG. 12 illustrates an example of a collection device including a squeegee.

FIGS. 13A and 13B illustrate another example of a collection device including a squeegee.

FIGS. 14A-14D illustrate various embodiments of a collection device with a built-in odometer.

FIG. 15 illustrates various examples of removal of liquid from a collection device swab.

FIG. 16 illustrates an example of a dissolvable swab.

FIG. 17 illustrates example steps for absorbing and removing liquid from a collection device swab.

FIG. 18 depicts a high level schematic block diagram of an example networked test system environment.

FIG. 19 depicts a flow chart of an example process for test data generation, analysis, and reporting.

FIG. 20 illustrates Congo Red reduction in well plate format in the presence of cisplatin and reducing agent in comparison to Congo Red and cisplatin without reducing agent and Congo Read and reducing agent without cisplatin.

FIG. 21 illustrates Congo Red reduction at different cisplatin concentrations in cuvette format.

### DETAILED DESCRIPTION OF THE PREFERRED EMBODIMENT

The singular terms “a,” “an,” and “the” are not intended to be limiting and include plural referents unless explicitly state or the context clearly indicates otherwise.

Embodiments of the disclosure relate to systems and techniques for detection of hazardous environmental contaminants, such as but not limited to noble metal-containing compounds, while minimizing exposure of the test operator to the contaminants. A kit for such testing can include a collection device and a testing device.

In some embodiments, provided herein is a method for detecting noble metal-containing compound contamination of a surface, the method comprising: collecting a sample comprising a noble metal-containing compound from said surface; contacting said sample with a dye and a reducing agent to form a test solution; and measuring the absorbance of the test solution at a particular wavelength. In some embodiments, the absorbance measurement may then be compared to a standard. In some embodiments, the color change of the test solution may be measured.

A sample may be collected from one or more work site surfaces according to aspects of the present invention. Such work site surfaces are those present at sites of manufacture, packaging, testing, use and/or disposal of the noble metal-containing compound. Non-limiting examples of work site surfaces from which a sample is collected, include bench tops, counters, desk surfaces, laboratory fume or isolation hoods, autoclaves, glassware, plasticware, clothing, floors, walls, ceilings, handles including door, drawer and cabinet handles, appliances and equipment surfaces.

In some embodiments, the presence of noble metal-containing compound contamination of a surface may be determined by measuring the rate of absorbance change and/or the rate of color change of the test solution. For example, in some embodiments, the absorbance or color change of the test solution may be measured every 1 second, 5 seconds, 10 seconds, 20 seconds, 30 seconds, 60 seconds, 2 minutes, 3, minutes, 5 minutes, 10 minutes, 15 minutes, 20 minutes, 30 minutes, 60 minutes, or more.

According to some aspects of the present disclosure, the absorbance of the test solution may be measured at one or more particular wavelengths. For example, the absorbance of the test solution may be measured at 200 nm, 210 nm, 220 nm, 230 nm, 240 nm, 250 nm. 260 nm. 270 nm, 280 nm, 290 nm, 300 nm, 310 nm, 320 nm, 330 nm, 340 nm, 350 nm. 360 nm, 370 nm, 380 nm, 390 nm, 400 nm, 410 nm, 410 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, or between any of the aforementioned values. For example, in some embodiments, the absorbance of the test solution can be measured at a wavelength between 490 nm and 510 nm. In other embodiments, the absorbance of the test solution can be measured at a wavelength between 460 nm and 480 nm. In yet other embodiments, the absorbance of the test solution can be measured at a wavelength between 660 nm and 680 nm.

Reducing agents that may be used according to aspects of the instant disclosure include, but are not limited to, lithium borohydride, lithium aminoborohydride, sodium borohydride, and sodium cyanoborohydride. In some embodiments, the reducing agent may be sodium borohydride. In other embodiments, the reducing agent may be lithium borohydride. In yet other embodiments, the reducing agent may be lithium aminoborohydride.

In some embodiments, the concentration of the reducing agent in the test solution may be in the range of 0.1 to 1000 mM. For example, the concentration of the reducing agent in the test solution may be 0.1 mM, 0.2 mM, 0.3 mM, 0.5 mM, 0.7 mM, 1 mM, 5 mM, 10 mM, 20 mM, 50 mM, 100 mM, 150 mM, 200 mM, 250 mM, 300 mM, 350 mM, 400 mM, 450 mM, 500 mM, 550 mM, 600 mM, 650 mM, 700 mM, 750 mM, 800 mM, 850 mM, 900 mM, 950 mM, 1000 mM, or in a range between any of the aforementioned values.

Dyes that may be used according to aspects of the instant disclosure include azo dyes. Examples of azo dyes include, but are not limited to, Acid orange 5, Acid orange 7, Acid Red 13, Acid red 88, Alcian yellow, Alizarine Yellow R, Allura Red AC, Amaranth (dye), Amido black 10B, Aniline Yellow, Arylide yellow, Azo violet, Azorubine, Basic Red 18, Biebrich scarlet, Bismarck brown Y, Black 7984, Brilliant Black BN, Brown FK. Brown HT, Chrysoine resorcinol, Citrus Red 2, Congo red, D&C Red 33, Direct Blue 1, Direct Blue 15, Disperse Orange 1, Eriochrome Black T, Evans Blue (dye), Fast Yellow AB, Orange 1, Hydroxynaphthol blue, Janus Green B, Lithol Rubine BK, Metanil Yellow, Methyl orange, Methyl red, Methyl yellow, Mordant Brown 33, Mordant red 19, Naphthol AS, Oil Red O, Oil Yellow DE, Orange B, Orange G, Orange GGN, Para red, Pigment Yellow 10, Ponceau 2R, Ponceau 3R, Ponceau 4R, Ponceau 6R, Ponceau S, Prontosil, Red 2G, Scarlet GN, Sirius Red, Solvent Red 26, Solvent Yellow 124, Sudan Black B, Sudan I, Sudan II, Sudan III, Sudan IV, Sudan Red 7B, Sudan Red G, Sudan stain, Sudan Yellow 3G, Sunset Yellow FCF, Tartrazine, Trypan blue, and Yellow 2G. In some specific embodiments, the azo dye may be Congo red. In other specific embodiments, the azo dye may be Methyl orange.

In some aspects of the instant disclosure, the dye may not be an azo dye. In some specific embodiments, the dye may be Methyl blue.

In some embodiments, the dye may be present in the test solution at a concentration in the range of 0.1 to 1000 μM. For example, the concentration of the reducing agent in the test solution may be 0.1 μM. 0.2 μM, 0.3 μM, 0.5 μM, 0.7 μM, 1 μM, 5 μM, 10 μM. 20 μM, 30 μM, 40 μM, 50 M, 100 μM, 150 μM, 200 μM, 250 M, 300 μM, 350 μM, 400 μM, 450 μM, 500 μM, 550 μM, 600 μM, 650 μM, 700 μM, 750 μM, 800 μM, 850 μM, 900 μM, 950 μM, 1000 μM, or in a range between any of the aforementioned values.

In some embodiments, the test solution may be an aqueous solution. In some embodiments, the aqueous test solution may optionally comprise a buffer. In some embodiments, the test solution may comprise an organic solvent. In some embodiments, the test solution may comprise an organic polar protic solvent. Organic polar protic solvents are well-known in the art and illustratively include, but are not limited to, methanol, propanol and ethanol.

Noble-metal containing compounds are described, for example, in N. Farrell, Metal Complexes as Drugs and Chemotherapeutic Agents, Comprehensive Coordination Chemistry II, 2003, 9, 809-840.

Various noble metal-containing compounds can be assayed using methods, devices and kits of the present disclosure. In some embodiments, the noble metal-containing compound include, but are not limited to drugs containing ruthenium, rhodium, palladium, platinum, silver, gold, osmium, iridium, or any combination thereof.

In some embodiments, the noble metal-containing compound may contain platinum. In some specific embodiments, the platinum-containing drug may be cisplatin, oxaliplatin, nedaplatin, carboplatin, triplatin tetranitrate, phenanthriplatin, picoplatin, satraplatin, or any combination thereof. In other embodiments, the noble metal-containing compound may contain ruthenium. In some specific embodiments, the ruthenium-containing drug may be sodium trans-imidazoledimethylsulfoxidetetrachlororuthenate(III), imidazolium trans-imidazoledimethylsulfoxidetetrachlororuthenate(III), sodium trans-[tetrachloridobis(1H-indazole)ruthenate(III)], or any combination thereof. In yet other embodiments, the noble metal-containing compound may contain gold. In some specific embodiments, the gold-containing drug may be gold sodium thiosulfate, gold sodium thiomalate, disodium aurothiomalate, aurothioglucose, auranofin, or any combination thereof.

In some embodiments, the noble metal-containing compound may be an antineoplastic drug. In other embodiments, the noble metal-containing compound may be an antibacterial agent. In yet other embodiments, the noble metal-containing compound may be an antiarthritic agent.

According to aspects of the present disclosure, devices that may be used in connection with detecting the presence of noble metal-containing compounds are described in International Patent Publication Nos. WO 2017/222833, WO 2019/060264, and WO 2019/060270, the contents of each of which are incorporated by reference herein in their entireties. Measurements may be performed, for example, in cuvettes with UV-Vis spectrophotometers, in well-plates with absorbance detectors, and in optical readers based on absorbance and/or reflectance.

In some embodiments, noble metal-containing compound contamination may be detected by contacting a sample containing the contaminant with a dye and a reducing agent. Detection methods can include a change in absorbance, a change in color, change in fluorescence, change in luminescence, change in electrical potential at a surface, change in other optical properties, or any other easily measured physical property indicating the presence or absence of a noble metal-containing compound in a sample.

The assay result can be compared to a standard according to preferred aspects of the invention.

Embodiments of the disclosure relate to systems and techniques for detection of hazardous environmental contaminants, such as but not limited to noble metal-containing compounds, and particularly noble metal-containing antineoplastic agents used in the treatment of cancer, while minimizing exposure of the test operator to the contaminants. A kit for such testing can include a collection device and a testing device. Throughout this disclosure, example systems, kits, and methods will be described with reference to collection, testing, and detection of noble metal-containing compounds, but it will be understood that the present technology can be used to collect, test, and detect any particle, molecule, or analyte of interest.

A collection device can include a swab and a container for sealing the swab after collection of the noble metal-containing compound. The swab can be constructed from a special material having desired pickup efficiency and shedding efficiency for detecting trace amounts of noble metal-containing compounds, and is provided on a handle having sufficient length so that the user can swab a surface without physically contacting the surface or the swab. A liquid can be provided within the container so that the user removes a pre-wetted swab to swipe the surface in one implementation. In another implementation, the user sprays the surface with a liquid and collects this liquid with the swab.

In some embodiments, the liquid may optionally include a small amount of an organic solvent. In some embodiments, the liquid may include 0.01-10% v/v of an organic solvent. In some embodiments, the liquid may include 0.01-10% v/v of an organic polar protic solvent. Organic polar protic solvents are well-known in the art and illustratively include, but are not limited to, methanol, propanol and ethanol.

The collection kit can further include a template, guide, or instructions to delineate a specific dimensional area for testing. In order to obtain an accurate test result for contaminants that are hazardous even in trace amounts, a precise method of marking (demarcation) and then performing the sampling procedure (for example, to sample all of the demarcated area and only the demarked area) can be a very important step to ensure an accurate result. There are several factors that can be key to obtaining an accurate drug concentration measurement given in the following formula:

$$C = \frac{∝ * A * {η}_{p} * {η}_{e}}{{V}_{b}}$$

where C is the concentration, α is the contamination surface density (ng/ft²), A is the surface area swabbed and tested, ηₚ is the pick-up efficiency, ne is the extraction from the swab density, and V_{b} is the liquid volume of the solution used to help extract and carry the contamination to the test cartridge. A goal of the described testing can be to have a high concentration signal with low variability. Excessive “noise” or variation in the variables may cause the test to either give false positive or false negative results. Test kits described herein can include mechanisms and/or instructions to users to assist in reducing the variation of each term in the above concentration equation.

After swabbing the surface, the user places the swab into the container and the handle forms a liquid-tight seal when engaged with the container. The handle can additionally lock to the container. The container can contain a liquid used as an agent to help remove the particles of interest embedded on the swab material into the liquid of the container. The container advantageously prevents liquid from spilling and contaminating surfaces or users, but provides for controlled release of liquid to a detection system. Non-limiting examples of such systems are referred to herein as “open system contaminant collection devices” and “open system detection devices.” Some implementations of the container can provide a liquid tight seal between the sample vial and the test cartridge so that harmful liquids, drugs or vapors would be contained and not vented into the atmosphere and possibly creating additional harm to the user. For example, the container can be structured to attach and/or seal to the detection system to provide a closed path for liquid transfer between the container and the detection system. Non-limiting examples of such systems are referred to herein as “closed system contaminant collection devices” and “closed system detection devices.”

The testing device can be an absorbance reader, for example a plate reader, microplate reader or a spectrophotometer, with an interface that alerts the user to the presence and/or degrees of contamination. Liquid can be released from the container into a cartridge in some embodiments. The cartridge can then be inserted into a reader to measure absorbance, determine a level of contamination, and report the determined level of contamination to the user. The reader can have more than one method of entering data regarding the sample and can have various ways of saving, storing, displaying, uploading and alerting the appropriate personnel when unacceptable levels of contamination are detected.

The reducing agent and dye used to detect the presence of a noble-metal containing compound may be contacted with the compound in one or more of the swab, the container, or the test cartridge. In addition, the reducing agent and dye may contact the test compound simultaneously or separately. Thus, for example, in various embodiments, both the reducing agent and dye are located in the swab, the container, or the test cartridge. In some embodiments, both the reducing agent and the dye are in solution the liquid within the container. Upon insertion of the swab into the container, the test compound is mixed with the reducing agent and the dye to permit detection. In other embodiments, both the reducing agent and the dye are located within the test cartridge. The test compound then contacts the reducing agent and dye upon transfer of liquid in the container to the test cartridge. In some embodiments, one of the reducing agent or dye is in the container, and the other is in the test cartridge. In various embodiments, the reducing agent and/or dye may be in solid or solution form prior to preparation of the test solution. For example, when in the container, the reducing agent and/or dye may be in solution. When in the test cartridge, the reducing agent and/or dye may be in solid form. In still other embodiments, the reducing agent and/or dye may be in solid form in the container, and then at the time of use, a liquid is added to the container to form a solution prior to contact with the swab.

In one example, after detecting contamination in an initial test there can be several possible next steps. A first option can be to remove the liquid tight connector and place the sample into another more sensitive test cartridge to determine an advanced level of detection. A second option can be to further dilute the sample to provide one or more additional levels of dilution, and to then take a hot or high magnitude signal. Once measured the dilution amount can be taken into effect and an actual concentration can be calculated based on the result and dilution amount.

The described swabs, liquids, and test devices can be configured to pick up and detect trace amounts of noble metal-containing compounds in some embodiments. It will be appreciated that the described systems can be adapted to collect and detect quantities of other noble metal-containing compounds in other embodiments. Further, the disclosed systems can be used in forensic, industrial, and other settings.

Specific collection device embodiments illustrated and described herein are characterized as having either an “open” or “closed” liquid transfer mechanism. However, it will be appreciated that the illustrated liquid transfer mechanisms are provided as non-limiting examples and that the disclosed swabs, containers, and other collection device aspects of each embodiment can, in various implementations, have either an open or a closed liquid transfer mechanism.

Although the disclosed detection devices are typically described herein with reference test cartridge reader devices, it will be appreciated that the described hazardous contaminant detection aspects described herein can be implemented in any suitable detection system. For example, features described herein can be implemented in reader devices that analyze other types of assays, such as but not limited to molecular assays, and provide a test result. Further, the collected liquid can be transferred to a centrifuge, spectrometer, chemical assay, or other suitable test device to determine the presence and/or concentration of one or more hazardous substances in the sample.

Although described in the example context of ascertaining the concentration of noble metal-containing compounds such as platinum-containing antineoplastic agents, it will be appreciated that the disclosed test cartridge and reading techniques for extending competitive assay dynamic range can be used to detect the presence and/or concentration of any analyte of interest. An analyte can include, for example, drugs (both hazardous and non-hazardous), antibodies, proteins, haptens, nucleic acids and amplicons.

Various embodiments will be described below in conjunction with the drawings for purposes of illustration. It should be appreciated that many other implementations of the disclosed concepts are possible, and various advantages can be achieved with the disclosed implementations.

### Overview of Example Open System Contaminant Collection Devices

A hazardous contamination detection kit can be used to identify and measure a specific area of surfaces to be tested and collect noble metal-containing compounds from those surfaces, for example in a pharmacy or in patient care/nursing areas. This kit includes a collection device for sampling the surfaces for possible contamination due to noble metal-containing compounds. After sampling, liquid from the collection kit can be transferred to a detection device. The detection device can include a test cartridge that includes the proper chemistry to detect the desired contamination in the surface sample and an assay reader configured with instructions for measuring absorbance and determining a concentration level of the contaminant. For example, in some embodiments, the test cartridge may include a dye. In some embodiments, the cartridge may include a reducing agent. In some embodiments, the cartridge may include a dye and a reducing agent. Some embodiments of the collection device can be “open.” referring to the transfer of liquid from the collection device to the detection device without use of a liquid-tight transfer mechanism. For example, liquid can be squeezed, poured, or dripped from the collection device into a test cartridge.

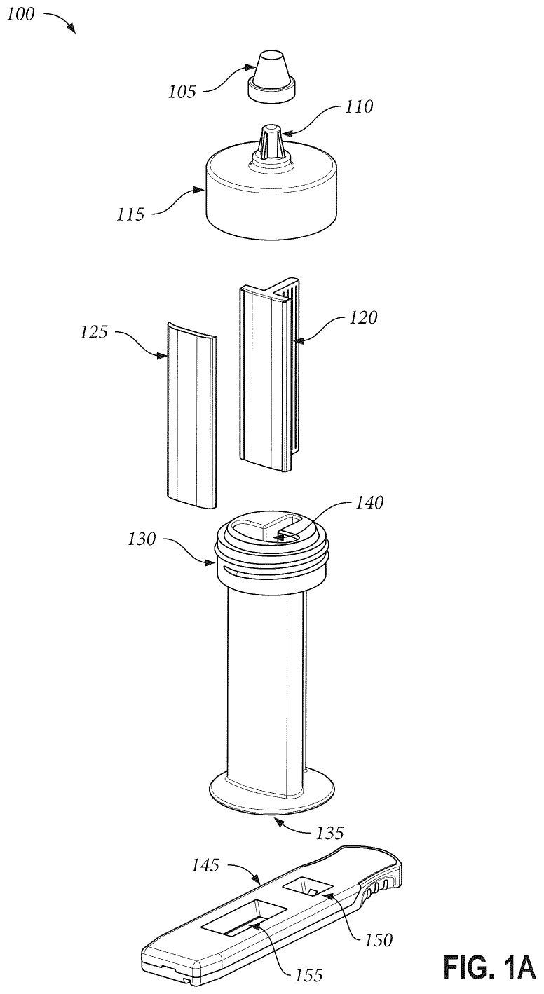

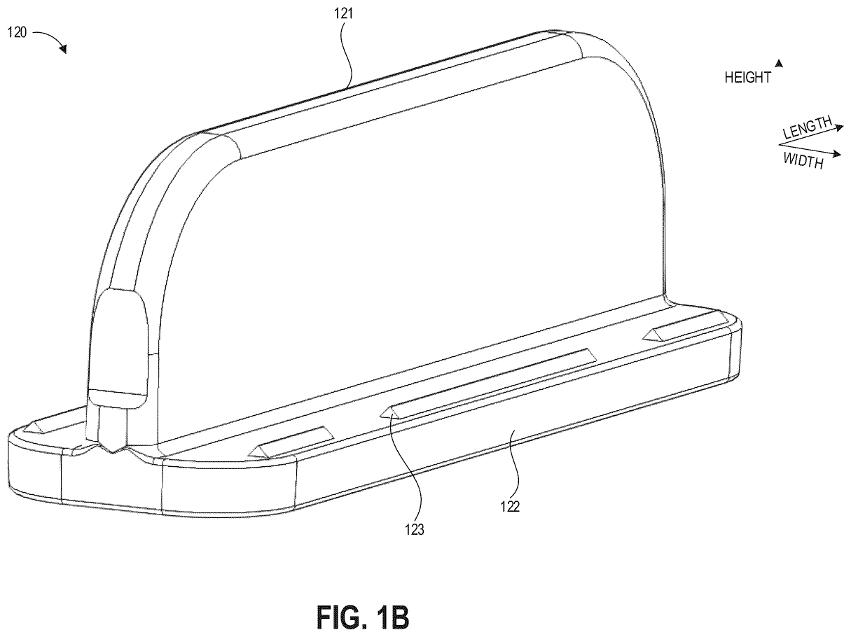

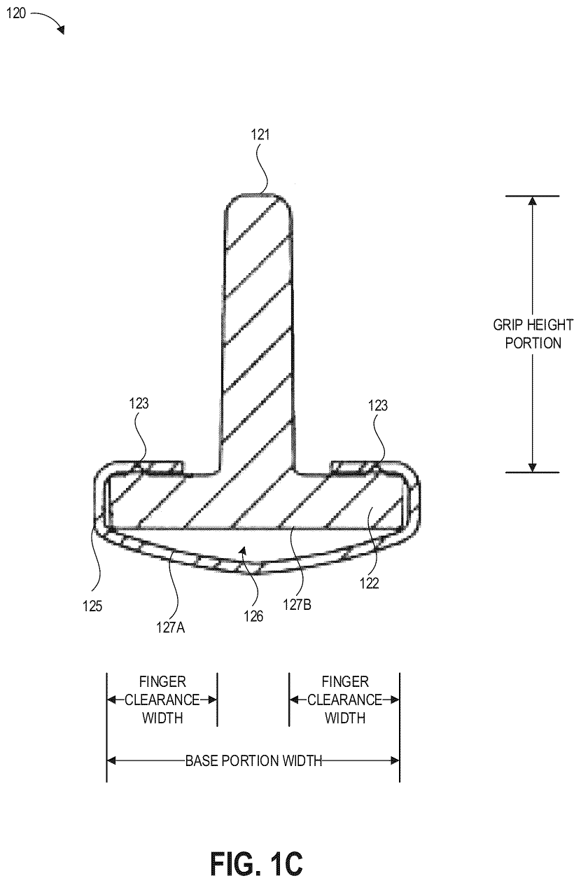

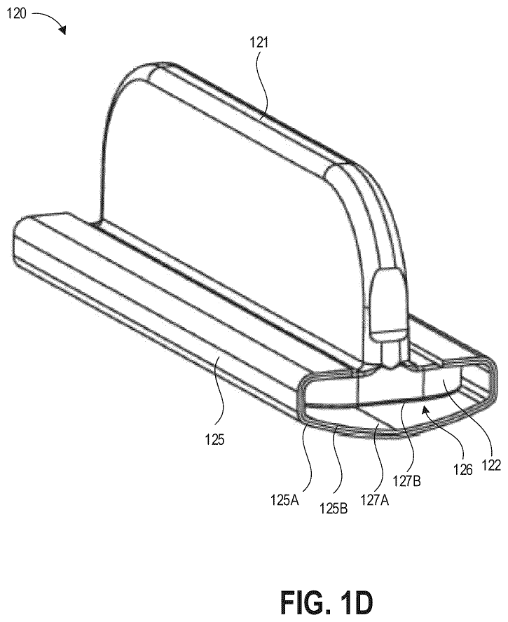

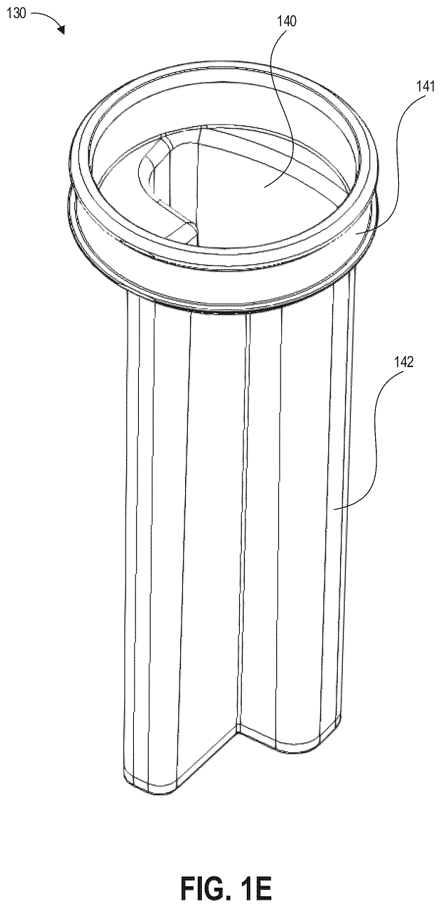

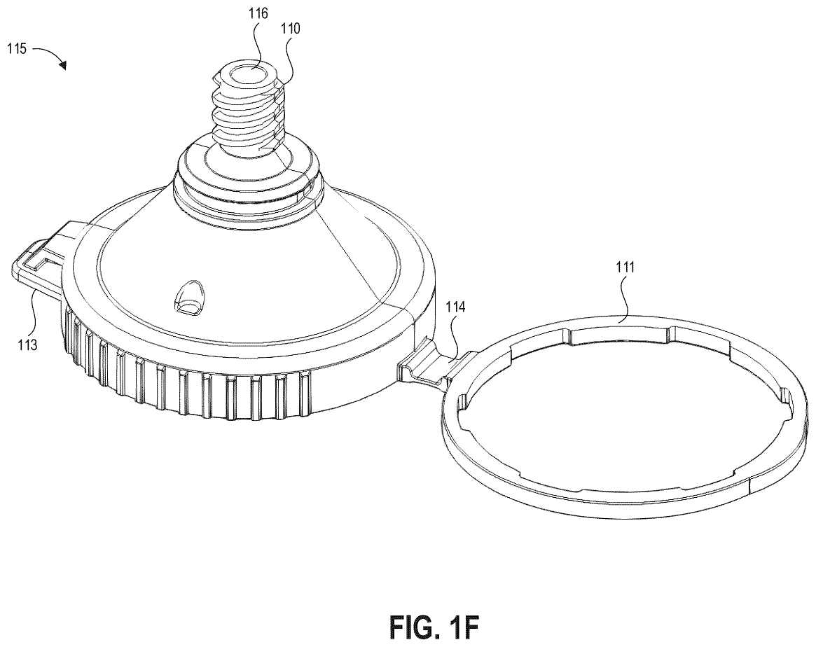

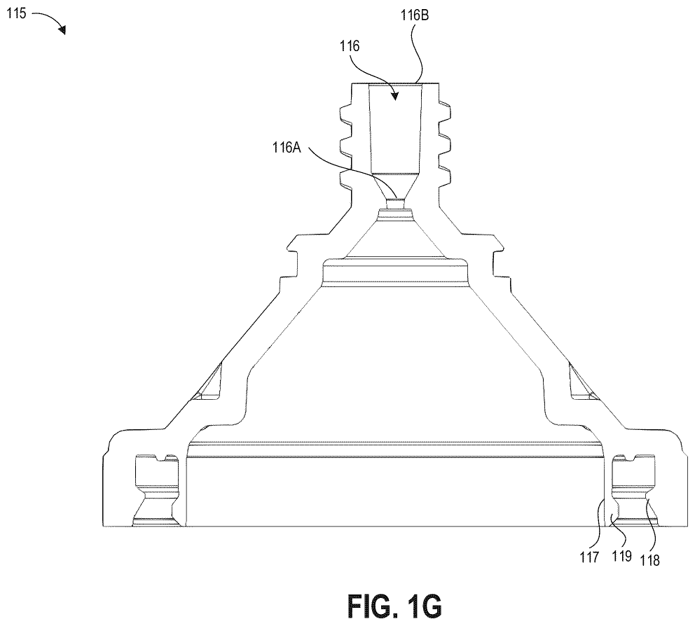

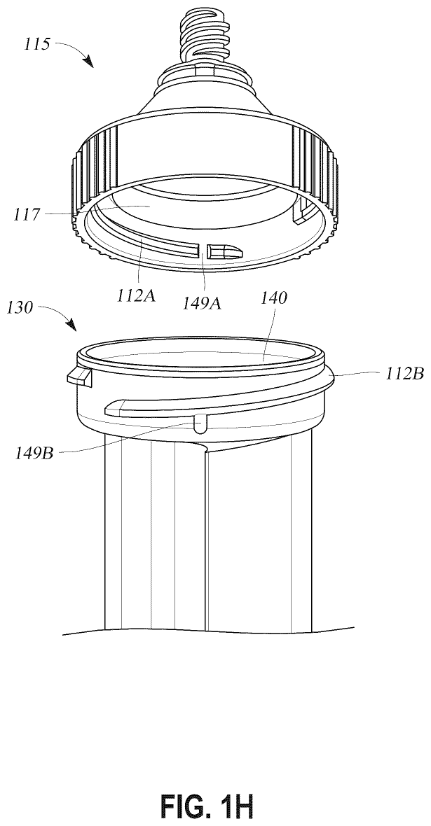

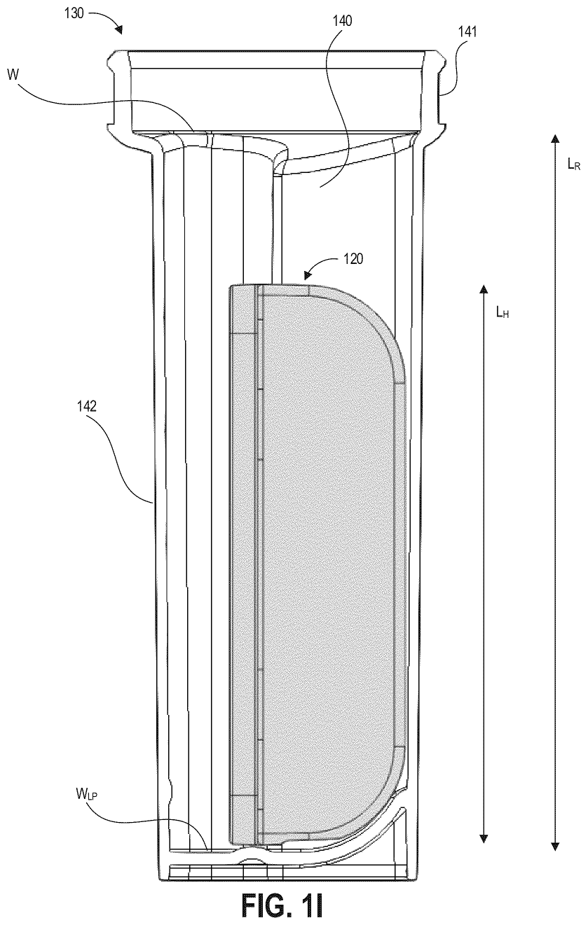

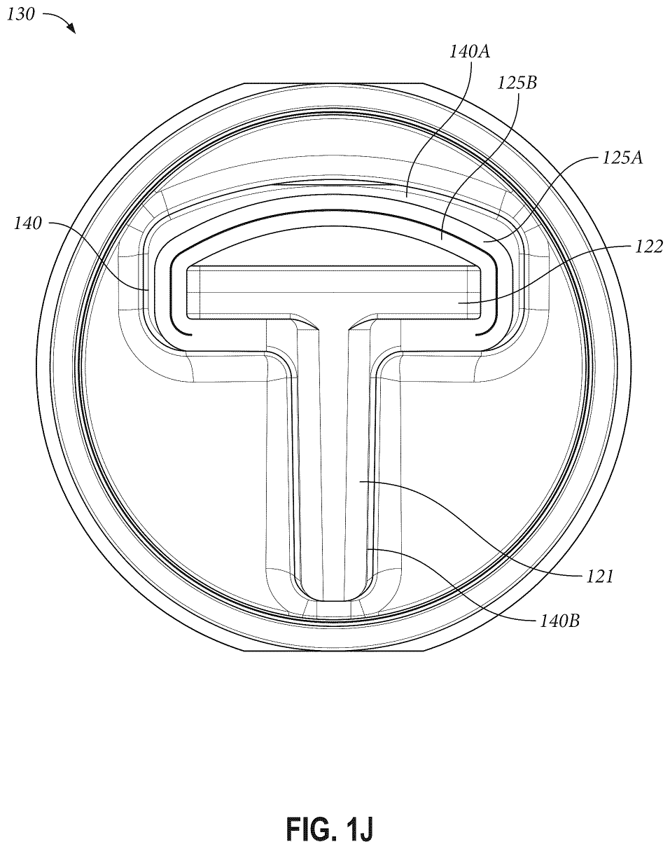

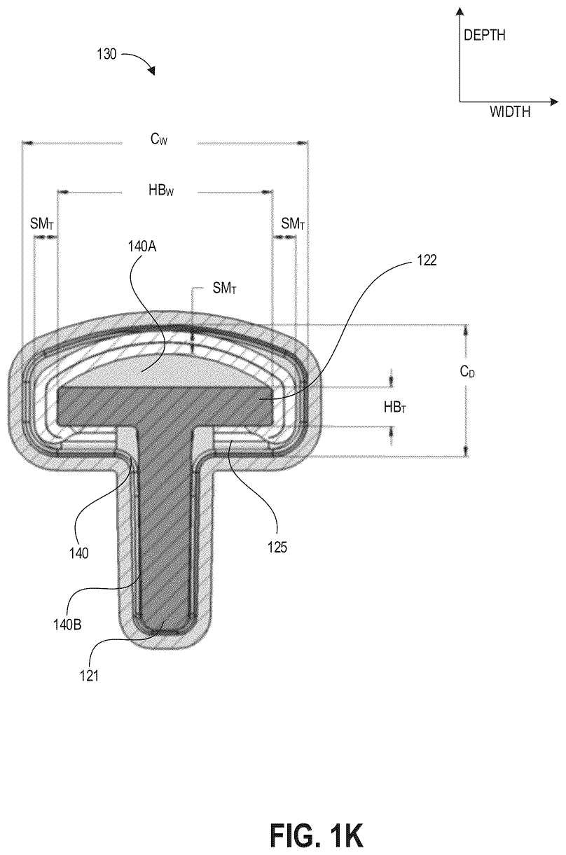

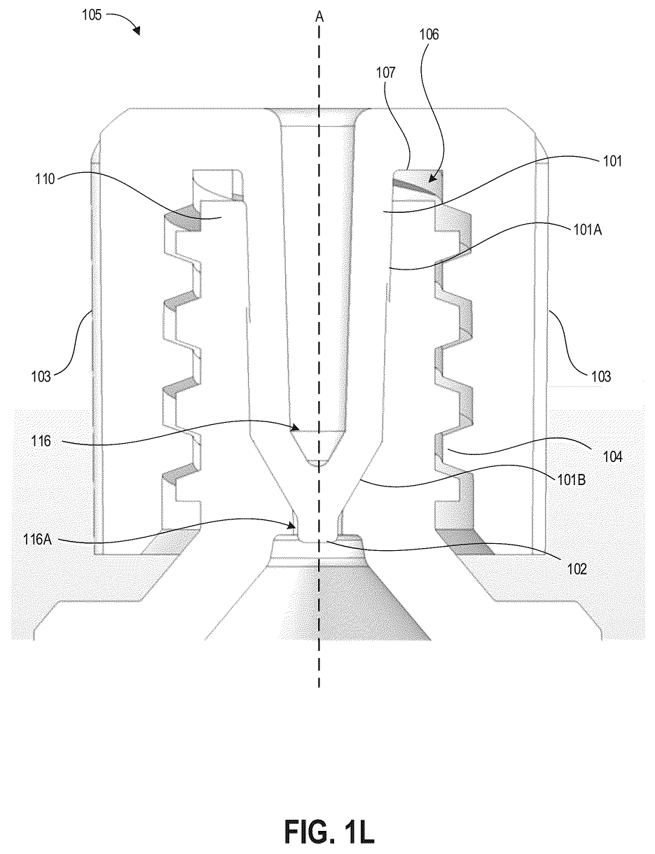

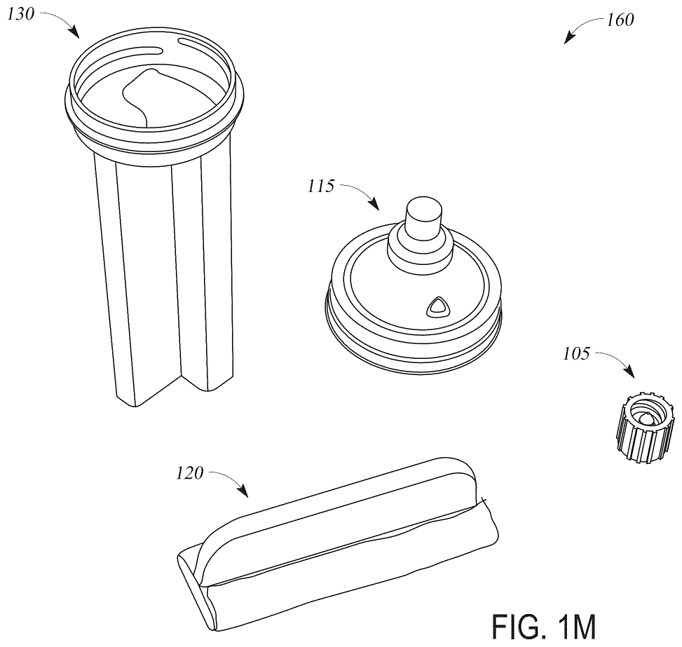

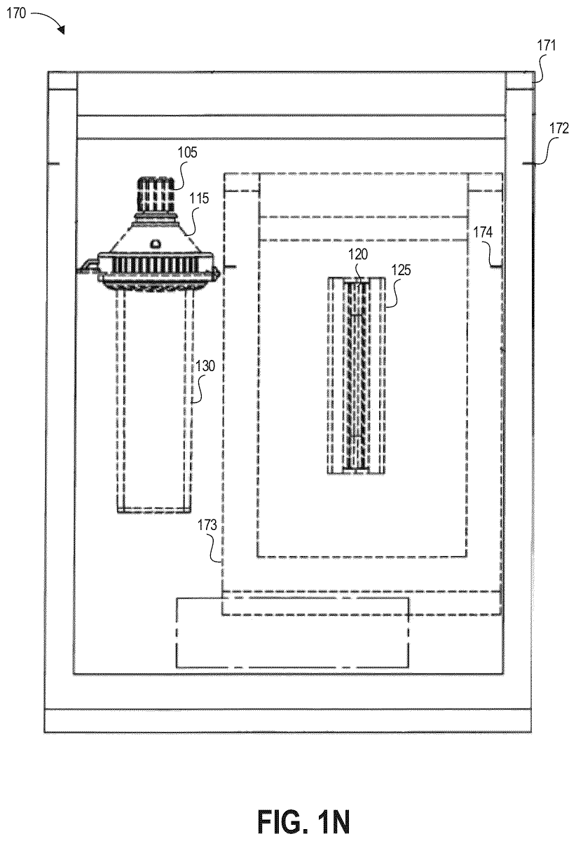

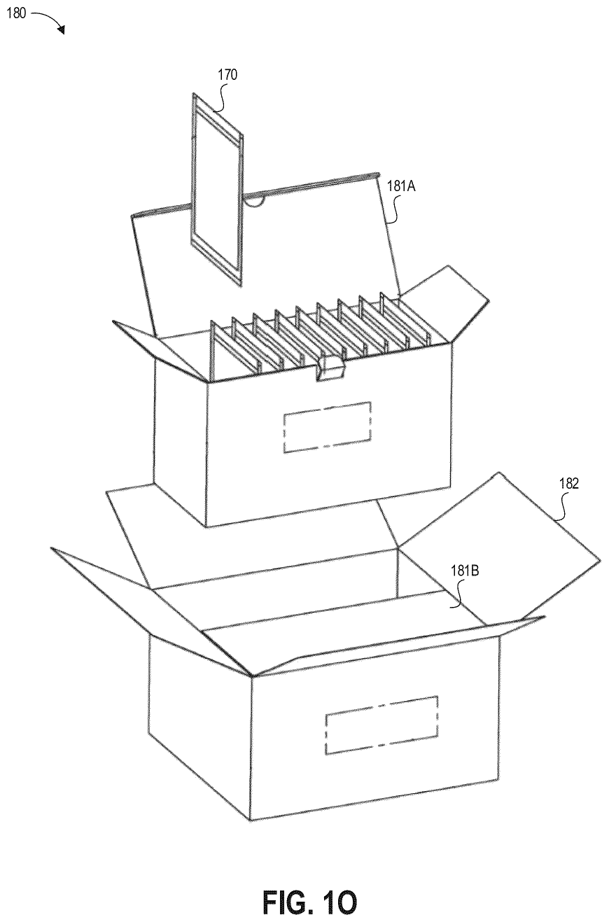

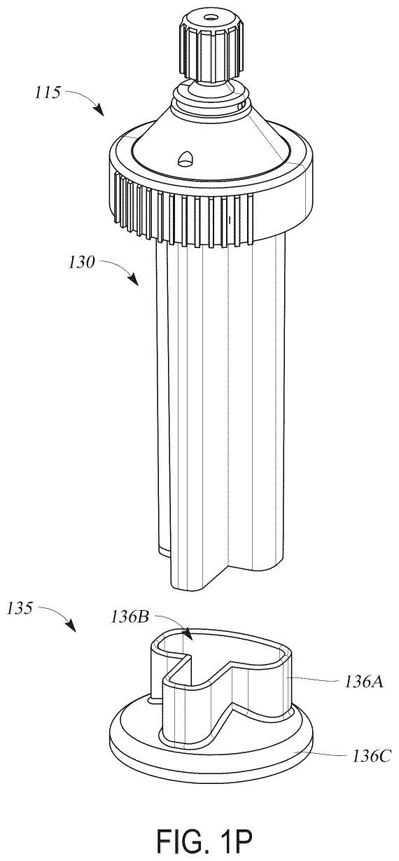

FIG. 1A illustrates an example of an open system contaminant collection device 100 and an open system detection device 145. In this example, detection device 145 is a test cartridge. The collection device 100 can include a container 130, a handle 120 with a swab 125, a removable top 115, and a removable cap 105. In some examples, components of the collection device 100 are packaged separately. For example, as will be described in greater detail below, the collection device 100 can include a first package and a second package. The first package includes a liquid-filled container 130 in sealed assembly with a removable top 115 and a removable cap 105. In some embodiments, the container may include a dye. In some embodiments, the container may include a reducing agent. In some embodiments, the container may include a dye and a reducing agent. The second package includes a handle 120 and a swab 125 that has been pre-moistened with liquid. The first package and the second package can be individually sealed (in some cases, hermetically sealed) and can be provided to the user in a kit described in greater detail below.

The container 130 can be liquid-tight when the container 130, removable top 115, and removable cap 105 are coupled together, and can contain liquid. The removable top 115 and container 130 can include threads for coupling as illustrated, or can include other suitable liquid-tight coupling structures, for example a snap fit. The container 130 can include a stability foot 135 to keep it oriented upright when positioned on a flat surface. The cap 105 can be threaded or configured to securely snap to the nozzle 110 of the removable top 115. The removable top 115 can be removed to provide access to the interior 140 of the container 130, allowing a user to remove the handle 120 and swab 125 from the container 130 and/or insert the handle 120 and swab 125 into the container 130. The removable top 115 also allows a user to pour liquid from the container 130 onto a test surface. In other embodiments in which the user uses the container 130 with a pre-moistened swab 125, the user may not pour any liquid from the container 130, thereby maintaining a known volume of liquid in the container 130. This feature can be beneficial for accurate assessment of collected contaminant concentration.

Components of the collection device 100 can be provided in any suitable configuration, depending on the needs of the user and the particular sample collection context. Components of the collection device 100 are described herein with reference to an example kit in which a pre-moistened swab material 125 and a handle 120 are provided in a first sealed package, and a container 130 filled with liquid, a removable top 115, and a removable cap 105 are provided in a second sealed package. Features of the example kit described herein advantageously limit exposure of the user to hazardous contaminants that are potentially present on a test surface while also very precisely controlling factors that can affect the accuracy of detection results (and in particular concentration measurements). It will be understood, however, that other configurations are possible. Some configurations are suitable for sample collection contexts where the analyte of interest is not a hazardous contaminant. For example, swab material 125 may be provided within the body of the container 130 and removed by the user prior to sample collection. Liquid may be included or not included within the body of the container 130. If liquid is not provided within the body of the container 130, a user can add liquid to the container 130 prior to sample collection (before or after removing the swab material 125 from the body of the container 130). A handle 120 may be provided within the body of the container 130 (for example, already coupled to the pre-moistened swab material 125), or it can be provided separately. If the handle 120 is provided separately, the user can remove the swab material 125 from the container 130 and attach it to the handle 120 prior to sample collection.

Though not illustrated, the container 130 can contain a certain volume of a liquid which will help lift the contamination from the swab material, keep the contaminate stable until it is ready to be transferred to the test cartridge, and provide a liquid suitable for transferring the contaminant to the test cartridge. Possible liquids are described in more detail below.

The handle 120 can have a “T-shaped” cross section with the “top” of the T for use in securing the swab 125 and the “downwardly-extending” portion of the T used as a grip. The size of the handle 120 can be selected to minimize usage of material while still providing a sufficient handle size to prevent contact between the hand of the user and the test surface. Some embodiments of a test kit can include protective gloves to provide a safeguard in addition to the handle 120 for preventing contact between the test operator and the test surface and/or testing liquids. Even where a kit does not include gloves, users can be instructed to use protective gloves during sampling and/or handling of samples.

The swab 125 can be constructed from a special material having desired pickup efficiency and shedding efficiency for detecting trace amounts of contaminants. Examples of swab materials are discussed in more detail below. Though shown in exploded view to illustrate the various components, the swab 125 can be coupled to the handle 120, thereby providing the user with a mechanism to wipe a test surface without contacting the surface and liquid. The swab 125 and handle 120 can be coupled, for example by ultrasonic welding to melt material of the handle 120 into portions of the swab material, a clamping mechanism built into the handle 120, by adhesive, or by any other suitable attachment mechanism. There may be one or multiple layers of swab material provided on the handle 120. The swab material may be attached to the handle 120 in a taut manner or may be loosely attached to the handle 120. The swab 125 can include two layers of fabric. In one advantageous embodiment described in detail below, the swab is attached to the handle 120 in a configuration where portions of the swab material that are not directly fastened to the handle 120 remain loose relative to the handle 120.

The interior 140 of the container 130 can be shaped to substantially conform to the outer dimensions of the coupled handle 120 and swab 125 in some embodiments so that the swab 125 and handle 120 can be securely fitted within the interior 140. In the illustrated example, the interior 140 has a “T-shaped” cross section that fits the profile of the handle 120 and swab 125. This shape of the container can minimize the volume of liquid needed to submerse a given portion of the handle in the liquid. It is also shaped to minimize the liquid that can reside around the grip portion of the “T” of the handle, thereby ensuring that most of the liquid will be in the portion of the interior 140 where the swab 125 is located. The shape of the interior 140 is designed such that most of the liquid volume will be around the swab 125 and the container/handle design may not allow the swab 125 to be compressed against the inside wall of the container 130, for example by providing additional space in the interior 140 around the swab 125.

In some embodiments, the length of the container interior 140 may be just long enough for the handle 120 to be fully enclosed in the interior 140, thus minimizing movement of the handle 120 when the container 130 is inverted. As such, as the container 130 is inverted the liquid moves back and forth across the swab 125. In another embodiment, the container 130 can be up to two times longer than the handle 120. This allows the handle 120 to slide back and forth with the liquid as the container 130 is inverted. This movement may aid in better flushing of the liquid through the swab 125.

In some embodiments the container 130 can contain a volume of liquid suitable for wetting a determined test area, for example corresponding to an area template or area instructions provided with the kit. A user can pour liquid from the container 130 onto the test surface and then wipe the test surface with swab 125. In some embodiments the liquid can be provided in a separate container. After being applied to the test surface, the liquid can be absorbed, together with any contaminants contained therein, by the material of the swab 125. As described herein, in some embodiments no liquid may be poured from the container 130, and instead the swab material 125 can be pre-moistened with the liquid (or a dilute version of the liquid).

In some embodiments the volume of liquid and swab 125 can be provided together within the container 130 before use so that swab 125 is pre-wetted with the volume sufficient for wetting the test area of the designated dimensions. In other embodiments the swab 125 can be provided separately in a sealed package to maintain its pre-moistened state. A user can remove the swab 125 and handle 120 and wet the test surface by wiping the swab 125 across the test surface, such as by applying pressure to release the liquid from the pre-wetted swab 125. The user can in some embodiments perform additional wiping of the test surface with the swab 125 after release of the liquid, for example until most or all of the liquid is re-absorbed into the swab 125.

After completing wiping of the test area of the test surface, the user can insert the handle 120 and swab 125 into the container 130 and couple the removable top 115 and removable cap 105 with the container 130 to enclose the liquid within the liquid-tight interior 140. The user can agitate the swab 125 within the sealed container 130 to shed collected particles from the swab material into the liquid. To transfer liquid from the interior 140 to the test cartridge 145, the user can remove the cap 105 and expel liquid through the nozzle 110, for example by inverting the container 130 and allowing liquid to drip through nozzle 110. The nozzle 110 can be sized and shaped for controlled release of a drop (or other volume) at a time of liquid into the test cartridge 145. A drop is an approximated unit of measure of volume corresponding to the amount of liquid dispensed as one drop from a dropper or drip chamber via gravitational pull (sometimes aided by a positive pressure created within the container holding the liquid). Though the precise volume of any given drop depends upon factors such as the surface tension of the liquid of the drop, the strength of the gravitational field pulling on the drop, and the device and technique used to produce the drop, it is commonly considered to be a volume of 0.05 mL.

In some embodiments, the interior volume 140 of the container 130 can be reduced in order to dispense the liquid into the test cartridge 145 for testing. This can be accomplished in several ways. In a first embodiment, the material of the container 130 is flexible enough to allow the user to squeeze the sides of the container 130 to expel controlled drops of liquid into the test cartridge through the orifice of the nozzle 110. The flexibility can come from a combination of container wall thickness and material modulus optimized so that the entire container 130 can be squeezed. In a second embodiment, the container 130 can have thin sections in the container wall, running either axially or radially, that give the container 130 hinge points where it can flex while the rest of the wall is thicker and stiffer. The user can then squeeze the container 130 which flexes at the thin hinge points thus reducing the interior volume forcing the liquid out through the drip orifice without the entire wall being thin enough to flex. In a third embodiment, a portion of the cap 115 that contains the nozzle 110 drip orifice is flexible to allow a change in volume while leaving the container inflexible. The whole cap 115 or part of the cap may be made flexible. The flexible portion may only be a single section or spot that allows enough deflection to push a drop of liquid out when compressed or deflected. Other configurations to expel a drop or other volume of liquid from the container 130 through the nozzle 110 in a controlled manner are possible. In other embodiments, the container 130 may not require squeezing to dispense liquid from the container, and may dispense drops of liquid upon inversion with cap 105 removed.

The test cartridge can include a sample receiving zone 150 and reaction zone 155. The user can transfer the liquid from container 130 to sample receiving zone 150 and fill enough of the volume within the test cartridge 145 so that the sample is present at the reaction zone 155. The reaction zone 155 can comprise a window through which the test solution may be visible to the detector. In some alternative embodiments, only a single window is present in the test cartridge 145, which may be used to both receive and detect the sample.

FIG. 1B illustrates a perspective view of an example handle 120 of the collection device 100 of FIG. 1A. The handle 120 includes a base portion 122 for securing swab material (not illustrated in FIG. 1B) and a grip portion 121 extending from the base portion 122. The grip portion 121 and base portion 122 can be formed as a unitary structure, for example via injection molded plastic. The base portion 122 includes a first portion 122A adapted to fasten to the swab material and a second portion 122B adapted to support the swab material 125 as it contacts the test surface. The first portion 122A and the second portion 122B can be on opposite sides of the base portion 122 as in the illustrated implementation, but other configurations are possible.

As illustrated, the grip portion 121 extends perpendicularly from the center of one face of the base portion 122. The grip portion 121 can extend away from the base at other angles and/or from other locations along the width of the base portion 122 in other embodiments. The grip portion 121 can have a height sufficient to keep the fingers of a user away from a surface in contact with the swab material secured to the base 122, for example 0.25 inches or more, or 0.5 inches or more, in various embodiments. In one non-limiting example, the height of the grip portion 121 is about 0.525 inches. The grip portion 121 can extend along the full length of the base portion 122 as illustrated, or can extend along just a portion of the length of the base portion 122. In some embodiments the width of the base portion can also assist in shielding the fingers of the user from the test surface, and the width can be for example 0.25 inches or more, or 0.5 inches or more, in various embodiments. In one non-limiting example, the width of the base portion 122 is about 0.55 inches. Embodiments of the base portion 122 with a width of about 0.55 inches can include about 0.2 inches clearance on each side of the grip portion 121 for the user's fingers to grip the handle 120. This can shield the user's fingers from the test surface below the base portion 122 during use of the handle 120, and can, for example, act as a stop to prevent the user's fingers from contacting the test surface. These example dimensions are illustrated in FIG. 1C for illustrative purposes only; other dimensions are possible and the handle 120 may not be drawn to scale. In some embodiments, the base portion 122 extends at least 0.1 inches beyond the user's finger on either side of the handle 120 when the user grips the handle 120.

The base portion 122 has a number of securing features 123 extending along at least a portion of the length of the base portion 122 from the same surface as the grip portion 121. As depicted, the securing features 123 can be a number of triangular prisms, for example two rows each having three axially-aligned triangular prisms. Other shapes, numbers, and configurations of the securing features are possible in other embodiments. FIGS. 1B and 1C depict the securing features 123 prior to attachment of the swab material. The swab material can be attached to these features 123 via ultrasonic welding in some embodiments. For example, the swab material can be positioned with a center portion along a face of the base portion 122 opposing the face with the securing features 123 with opposing edges of the swab material wrapped around the sides of the base portion 122 and positioned over the securing features. Ultrasonic energy can be applied to the securing features 123, causing the material of the features to melt or liquefy and flow into the fabric of the swab material. When the energy is removed the melted material solidifies, providing a mechanical attachment between the handle 120 and the swab material. Other mechanisms to attach the swab material to the base portion 122 are possible. In other embodiments the securing features 123 can be omitted and other mechanical fasteners (e.g., pins/screws) and/or adhesive can be used in place of the securing features.

FIG. 1C depicts a cross-sectional view of the handle 120 having swab material 125 secured to the securing features 123 as described above, and FIG. 1D depicts a perspective view of the handle 120 and secured swab material 125. As depicted in FIG. 1D, in this non-limiting example the swab material 125 is formed from a material, for example woven polyester, folded or stacked into two layers 125A, 125B. The opposing edges of this dual-layer fabric are positioned over the securing features 123 (shown in cross-section FIG. 1C but obscured by the fabric in FIG. 1D) with the melted material of the securing features 123 solidified within the open space of the weave, thereby securing some of the woven fibers of the swab material 125 within the solidified securing feature material. Although FIG. 1C depicts the solidified securing features 123 in their original triangular configuration, due to the melting and solidification process other shapes are possible. Portions of the swab material 125 can be secured to first portion 122A of the base portion 122 of the handle 120 such that other portions of the swab material proximal to the second portion 122B of the base portion 122 remain loose relative to the handle 120. The swab material is configured to be loose enough to form a gap 126 between the surface 127A of the swab material 125 and the surface 127B of the second portion 122B of the base portion 122. The gap 126 can enable the swab material 125 to be agitated by liquid to extract collected contaminants from the swab material 125, and can be between 0.25 inches and 0.75 inches in some embodiments. The swab material 125 may be longer than the base 122 of the handle such that around 0.25 inches extends beyond the edges of the base 122. Other embodiments can use greater or fewer than two layers for the swab material 125, and can use separate pieces of fabric (for example, layered and then cut and sealed along the opposing edges that are wrapped over the securing features) or a single length of folded material.

FIG. 1E illustrates an example collection container 130 of the collection device of FIG. 1A. The collection container 130 has a circular upper rim 141 and a well wall 142 extending from the rim 141 and forming a well 140. The collection container 130 can be formed from an injection-molded plastic in some embodiments. The rim 141 can include a recessed portion between ridges for securing a retaining ring of a snap top as in the illustrated embodiment, with the ridges used to secure the snap top in place. In another embodiment, the rim 141 can be threaded in a corresponding manner with a threaded top. The well 140 can be formed with a T-shaped cross-section as illustrated to substantially match the shape of the handle 120. The well wall 142 can have uniform or substantially uniform (e.g., within acceptable manufacturing tolerances) walls in some embodiments such that the outer shape of the container 130 matches the cross-section of the well 140.

FIG. 1F illustrates a perspective view of the top of an example removable top 115 of the collection device of FIG. 1A, and FIG. 1G illustrates a cross-sectional side view of the removable top 115. The illustrated removable top 115 is configured to snap or press-fit onto the ridges of the upper rim 141 of the container 130. Other embodiments can include a threaded or other suitable connection rather than a snap or press-fit connection. For instance, the example collection device 100 described below with reference to FIG. 1H includes a threaded removable top 115 configured to engage a threaded container 130. Embodiments of collection devices 100 according to the present disclosure can advantageously create a liquid-tight seal between the removable top 115 and the container 130 with minimal user force and with the fewest number of components, thereby reducing risk that the user will not create a liquid-tight seal when the user engages the removable top 115 to the container 130.

The removable top 115 includes a frustoconical body with, a threaded nozzle 110 at the tip of the frustoconical body including liquid outlet channel 116, a tab 113 to assist a user in removing the top 115, and interior features including a cylindrical wall 117 and one or more detent(s) 118. The nozzle 110 need not be threaded and may interact with a removable cap 105 via a snap or press-fit connection, or any other suitable mechanism. The removable top includes a hinge 114 attaching a retaining ring 111 to the frustoconical body. Some embodiments can omit the tab 113, the retaining ring 111, and the hinge 114.

On the underside of the frustoconical body is the cylindrical wall 117 spaced apart from the detent(s) 118. The detent(s) 118 can include one or more protrusions extending from the inner rim of the top 115 towards the wall 117 or can be formed as a continuous annular feature. The cylindrical wall 117 includes a protrusion 119 that faces the detent(s) 118. Similar to the detent(s) 118, the protrusion 119 can include one or more protrusions or a continuous annular feature. The detent(s) 118 and cylindrical wall 117 are configured to secure the removable top 115 to the upper rim 141 of the container by positioning the upper rim 141 of the container 130 between the detent(s) 118 and the protrusion 119. For example, the protrusion 119 can be pressed into the inside of the mouth of the container opposite the rim 141 that extends around the exterior of the mouth of the container. This can seal the top 115 to the container 130. In one non-limiting example, the hoop strength of the cylindrical wall 117 and protrusion 119 combined with the deflection of the cylindrical wall 117 provides a normal force that seals the protrusion 119 to the inside wall of the container 130. The detent(s) 118 can secure to corresponding detents in the upper rim 141 of the container 130 to securely hold the top 115 onto the container 130, as well as to provide tactile and/or audible “click” feedback to the user to indicate that the top 115 is securely in place. Similar detents can be provided in a threaded embodiment of the top 115. Securing the top 115 to the container 130 beneficially prevents spillage of the liquid, which potentially contains hazardous materials after the handle 120 is inserted into the container 130. Beneficially, embodiments of collection devices 100 described herein that include the wall 117, protrusion 119, and detent 118 can mitigate spillage of liquids from within the well 140 of the container 130 without the use of a separate sealing member or gasket. Accordingly, the collection devices 100 according to the present disclosure advantageously limit the number of total number of individual, separate components while also providing a liquid-tight seal, thereby limiting the risk of failure of components, the risk that components will not be aligned properly when assembled, and the risk that components will not operate as intended to create a liquid-tight seal. As one example, conventional collection devices that use sealing gaskets to create liquid-tight seals may fail if the gasket is cracked, torn, misaligned, or has even a minute defect or flaw due to chemical breakdown (which can occur with age) or faulty manufacturing. Embodiments of the collection device 100 advantageously mitigate these and other risks to minimize the potential that a user will be exposed to hazardous materials, including highly toxic contaminants that are extremely hazardous to human health even in minute amounts.

As shown in FIG. 1G, the inner aperture 116A of the channel 116 can be smaller than the outer aperture 116B of the channel 116. Accordingly, the channel 116 in this non-limiting embodiment is a tapered channel within the nozzle 110. The taper of the channel 116 can advantageously promote consistent drop sizes (consistent volume, consistent shape, etc.) for dripping liquid out of the well 140 through the nozzle 110, for example into a test cartridge as shown in FIG. 1A.

FIG. 1H illustrates an example collection device 100 in which the removable top 115 and the container 130 are coupled using a threaded engagement rather than a snap- or press-fit engagement. FIG. 1H also illustrates an example of the detents discussed with respect to FIGS. 1F-1G in a threaded embodiment of the removable top 115. The removable top 115 includes threads 112A positioned along the internal surface of its lower rim. The container 130 includes corresponding threads 112B positioned along the external surface of its upper rim. The threads 112A, 112B are configured to engage and mechanically mate with one another. The threads 112A of the removable top 115 have at least one gap 149A where the axial spiral of the threads 112A are interrupted and a negative space is formed. The container 130 includes a corresponding number of bump(s) 149B that align with the position of the gap 149A when the top 115 is screwed onto the container 130. The gap 149A and the bump 149B thus function as the detent described above to provide tactile and/or audible feedback to the user when the top 115 is correctly aligned with and fully threaded onto the container 130. In one example, the top 115 is provided with two gaps 149A on opposing sides of the threads 112A and the container 130 is provided with two corresponding bumps 149B. Thus, in some embodiments the described detent can be a combination of one or more gaps in the top threads that correspond with one or more bumps on the container to cause a snap or click when the top is fully screwed on.

FIG. 1I illustrates a cutaway side view of the collection container 130 of FIG. 1E with the handle 120 of FIGS. 1B-1D positioned within the collection container 130. FIG. 1I shows the rim 141 forming a cylindrical opening leading into the T-shaped well 140. The handle 120 is depicted without the swab material attached in FIG. 1I. As illustrated, in this non-limiting embodiment the length L_{H} of the handle 120 is less than the length L_{R} of the interior of the well 140 that extends from the highest point of the well W_{HP} to the lowest point of the well W_{LP}. In some embodiments, the difference between the length L_{H} of the handle 120 and the length L_{R} of the interior of the well 140 can be at least ⅛th inches, and preferably between ⅛th inches and ¼ inches. In one example implementation, the length L_{H} of the handle 120 is 2 inches and the length L_{R} of the interior of the well 140 is 2.25 inches. Providing a well with a greater length than the handle advantageously increases the amount of contaminant flushed from the surface of the swab material, for example when the user inverts container 130 and liquid in the container 130 washes back and forth across the swab material to remove any picked-up contaminants. While the user inverts the container the handle 120 slides back and forth within the well 140 to provide for better washing of the fabric than in implementations having the same length for the handle and well.

FIG. 1J illustrates a top view of the handle 120 positioned within the well 140, and depicts a representation of the swab material 125 (shown in two layers 125A, 125B) secured to the handle. As illustrated, the swab material 125 can be secured loosely to the base portion 122 of the handle 120 such that there can be a gap between the inner layer 125B of swab material and the surface of the base portion 122 facing the inner layer 125B. For example, the swab material 125 can be between 0.050 inches and 0.220 inches longer than the width of the handle. This results in portions of the fabric remaining loose relative to the surface 127B of the handle 120 and forming a gap 126 between the swab material and the handle 120 in which liquid can freely flow, thereby allowing liquid to efficiently pass through and agitate the portion of the swab material that made direct contact with the test surface. The layers 125A, 125B can have the same or different widths across the width of the base portion 122.

The well 140 includes a first portion 140A sized to receive the base portion 122 of the handle 120 with the swab material 125, and the well further includes a second portion 140B sized to receive the grip portion 121 of the handle 120. In examples such as that illustrated in FIG. 1J, the second portion 140B is sized to snugly receive the grip portion 121 of the handle 120 (in other words, there is very little space between the second portion 140B and the grip portion 121 such that their surfaces are in constant contact or near constant contact). As illustrated, the second portion 140B has a substantially similar cross-section to the grip portion 121, where “substantially” refers to a cross-section of the second portion 140B being slightly larger to allow the grip portion 121 to slide into the second portion 140B. The cross-section of the first portion 140A corresponds to the cross-sectional area occupied by the base portion 122 of the handle 120 with the swab material 125 with a small gap to allow the swab material 125 to flow freely in the liquid in the well 140. Beneficially, providing the second portion 140B to have a similar interior volume to the volume occupied by the grip portion 121 causes the grip portion 121 to push most if not substantially all liquid in the well 140 out of the second portion 140B and into the first portion 140A when the handle 120 is inserted into the container. This can reduce the amount of liquid required to be placed in the well 140 in order to wash the desired amount of contaminants from the swab material 125, which beneficially increases the concentration of the contaminants in the solution compared to other embodiments that require greater amounts of liquid. The first portion 140A can be sized to substantially match the shape of the handle's base portion 122 with swab material attached, though the first portion 140A can (as illustrated) be slightly larger in order to facilitate agitation of the loose swab material during inversion of the container 130.

As such, the complementary shapes of the well 140 and handle 120 (including swab material 125) provide at least the following benefits: (1) minimizing unneeded “dead space” (e.g., space not occupied by handle 120 or swab material 125) inside the well 140 when the handle is inserted into the well 140, thus reducing the volume of liquid needed to extract contaminants from the swab material; and (2) maximizing concentration of the contaminant in the solution by promoting agitation of the material to extract the contaminant. Regarding unneeded “dead space” and the first portion 140A, a small amount of space is beneficial around the swab material 125 in order to allow the swab material to flow within the liquid and be agitated by turbulence during container inversions, thereby releasing the maximum quantity of collected contaminant from the swab material 125 into the solution. However, providing too much dead space creates a requirement for a greater amount of liquid to contact the swab material 125, thereby reducing the concentration of collected contaminant in the liquid. The complementary shapes of the well 140 and handle 120 thus enable accurate detection of even minute quantities of collected contaminants by maximizing both contaminant shedding from the swab material 125 and contaminant concentration in the liquid.

Although the sides of the grip portion 121 and second portion 140B of the well 140 are depicted as being straight, in other embodiments the sides of the grip portion 121 and the inner walls of the second portion 140B of the well 140 can be “keyed,” that is, have corresponding features (e.g., curved or angled portions). Embodiments having a keyed grip portion 121 and second portion 140B beneficially can maintain the positioning of the grip portion 121 fully within the second portion 140B rather than allowing the base portion 122 to slide toward the far side of the first portion 140A of the well.

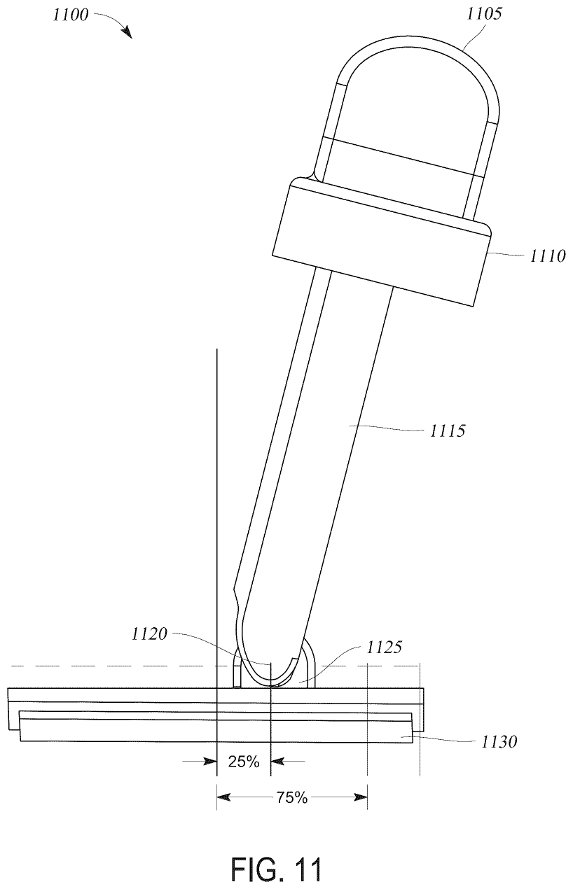

FIG. 1K illustrates example dimensions of portions of the handle 120, well 140, and swab material 125 in order to illustrate and not limit the described complementary shapes of the handle and the well. In one embodiment, the base portion 122 of the handle 120 has a width HB_{W} of about 0.55 inches, the swab material 125 has a thickness SM_{T} of about 0.06 inches and thus the combined width of the handle (between the base portion 122 and the four layers of swab material 125) is about 0.67 inches. The greatest width C_{W} of the first portion 140A of the container well is about 0.73 inches at a highest point WHIP (see FIG. 1I) along the height of the well. The width of the well can taper along the height of the well to be about 0.67-0.69 inches at a lowest point W_{LP} (see FIG. 11) of the well. Thus, the width C_{W} of the first portion 140A can match or substantially match (e.g., at a smallest point along a tapered width) the total width of the handle base 122 and layers of swab material 125. In this embodiment, the platform of the base portion 122 of the handle 120 has a thickness HB_{T} (with this thickness measured along the height of the handle) of about 0.1 inches and the two layers of swab material 125 positioned between the base 122 and the opposing wall of the well 140 have the thickness SM_{T} of about 0.06 inches. The greatest depth C_{D} of the first portion 140A of the container well is about 0.338 inches, which gives the 0.06 inches of swab material 125 about 0.238 inches (at the deepest point of the first portion 140A) through which the material can move loosely and freely during agitation. liquid can flow freely through this portion of the material, passing back and forth between the surface of the material that made direct contact with the test surface and the opposing surface of the material, thereby releasing analytes of interest captured in the material into the liquid with greater efficiency and in greater numbers. As described above, in some embodiments the handle 120 and well 140 can be “keyed” by providing corresponding features along the cross-section of the second portion 140B of the well 140 and the grip portion 121. This keying can ensure that the relative positioning of the handle 120 along the depth of the well is maintained as shown with the grip portion 121 positioned fully back into the second portion 140B, causing all or substantially all liquid to be forced out of the second portion 140B of the well 140 by the grip portion 121 and maintaining the distance of 0.238 inches (at the deepest point) through which the liquid can flow freely through the swab material 125.

FIG. 1L illustrates a cross-sectional view of an example removable cap 105 of the collection device of FIG. 1A secured onto the threaded nozzle 110 of the top 115. The cap 105 can include grip features 103 to facilitate a user turning the cap. As described above, the cap 105 need not be threaded and can interact with the top 115 using other suitable mechanisms, such as but not limited to a snap or press-fit mechanism. The removable cap 105 includes a cavity 106 lined with threads 104 for screwing onto the threaded nozzle 110 of the top 115. The cap 105 also includes a protrusion 101 extending into the cavity 106. The protrusion 101 is configured to plug the orifice 116 of the nozzle 110 of the top 115 with the upper wall 107 of the cavity sealing against the top surface of the nozzle 110. The protrusion 101 can be tapered to match the tapered contours of the channel 116. The protrusion 101 has at its lowest region (e.g., the region positioned furthest within the channel 116 when the cap 105 is screwed onto the nozzle 110) a post 102 that extends into the inner aperture 116A of the channel 116. This shaping of the cap 105 can serve to minimize any “dead space” in the channel 116 of the top 115 that could collect liquid in a manner that interferes with test result accuracy. For example, without the described features of the cap 105, liquid could collect within the channel 116 of the top 115 and stay in the channel 116 as the swab material 120 is agitated to release collected contaminants. This “trapped” liquid would be the first liquid to drip out of the container 130 due to its positioning in the channel 116, but it may not have mixed with the rest of the solution during agitation and thus would not contain any (or a great quantity of) collected contaminants. Additional features of the cap 105 according to the present disclosure advantageously avoid these potential issues. For example, the protrusion 101 of the cap 105 has an exterior shape that corresponds to the inner shape of the channel 116, thereby preventing liquid from accumulating within the channel 116 of the top 115. In one example, the protrusion 101 and the channel 116 have a first segment 101A angled at around 3.7° relative to a central axis A of the channel 116, with the first segment 101A forming a primary/largest sealing surface between the protrusion 101 and the channel 116. The first segment 101A can be followed by a second segment 101B angled at around 60° relative to the central axis A of the channel 116, where this second segment 101B acts as a stop to indicate to the user that the cap 105 has been fully threaded onto the nozzle 110. One or more detents may be included to facilitate providing such an indication to the user. The post 102 is sized to fill the inner aperture 116A of the top 115 without interference, and the post 102 and engaged surfaces of the second segment 101B cooperate to prevent liquid from entering the channel 116 when the cap 105 is fully screwed onto the nozzle 110 of the top 115.

FIG. 1M illustrates an example set 160 of the components of FIGS. 1A-1L that can be included in a collection device kit. The set 160 includes the container 130, top 115, cap 105, and handle 120 (including swab material). The kit can be packaged such that the container 130 is provided with a specified volume of liquid in the well and then sealed with the top 115 and the cap 105. The handle 120 can be packaged separately within the kit, and can be pre-moistened with a diluted version of the liquid within the container 130. FIG. 1L1M depicts a threaded version of the container 130 and top 115.

FIG. 1N illustrates an example collection kit 170 including the set 160 of components of FIG. 1M. The collection kit 170 includes a first container 171 that houses assembled container 130, top 115, and cap 105 (containing a volume of liquid as described herein) and also houses a second container 173. The first container 171 can be a heat-scaled polymer pouch with tear slits 172 in some embodiments. The second container 173 is a sealed enclosure housing the assembled and pre-moistened swab material 125 and handle 120. The second container 173 can be a heat-sealed polymer pouch with tear slits 174 in some embodiments. For example, the assembled swab material 125 and handle 120 can be placed on a portion of the film that forms the second container 173, sprayed or otherwise provided with a dilute version of the liquid in the container 130, and then the second container 173 can be sealed around the moistened swab. The second container 173 can be a metalized polymer that includes a foil or metal in the material forming the pouch of the second container 173. Metalized polymer containers can advantageously maintain and preserve liquid, such as liquid that has been provided to the swab material 125, during shipping and storage.

In order to use the set 160 of components to perform wiping of a test surface as described herein, the user can open the first container 171 of the collection kit 170 and remove the container 130 with the top 115 and cap 105 attached and with the reagent and liquid already within the well of the container 130. The user can remove the second package 173 with the separately packaged handle 120 with the swab material pre-attached and pre-moistened with the dilute version of the liquid in the container 130, open the second package 173, and wipe the test surface with the pre-moistened swab material. The user can remove the top 115 from the container 130 to provide access to the well 140. After completing the wiping of the test surface, the user can slide the handle 120 into the well 140 of the container 130, close the top 115 onto the container 130, and invert the container 130 (e.g., flip it 180 degrees) a number of times, for example 5 or more times. As discussed above, inverting the container 130 washes the swab material with the liquid and extracts any contaminants picked up from the test surface. After completing the recommended number of inversions of container 130, the user can remove the cap 105 and drip the liquid (and any contained contaminant particles) into a test cartridge through the orifice 116.

FIG. 1O illustrates an example package 180 that includes a number of collection kits 170. The package 180 includes two shelf boxes 181A, 182B that each can house, for example, ten collection kits 170. The shelf boxes 181A, 182B are provided within a larger shipping container 182. Optionally, the shipping container 182 can also include templates to demarcate the test surface and assist the user during sample collection, assay test cartridges, and/or assay reader devices as described herein.

FIG. 1P illustrates an example stability foot 135 that can be used with the collection container of FIG. 1E. In FIG. 1A, the stability foot 135 is shown as integrated into the collection container 130. However, in other embodiments the collection container 130 can be formed separately from the stability foot 135, as shown in FIG. 1P. The stability foot 135 can include a T-shaped wall 136A defining a T-shaped aperture 136B sized to snugly receive the bottom of the container 130, with the T-shaped wall 136A extending upwardly from a wider base portion 136C. The base portion 136C can contact a surface on which the container 130 is set and provide stability so that the container 130 is not as easily tipped. The bottom of the container 130 can be press fit into the aperture 136B, or it can have snap features such as a bump on the container that fits into a recess on the interior of the T-shaped wall 136A (or vice-versa) to provide the user with tactile and/or audible feedback of the container 130 being positioned correctly within the stability foot 135.

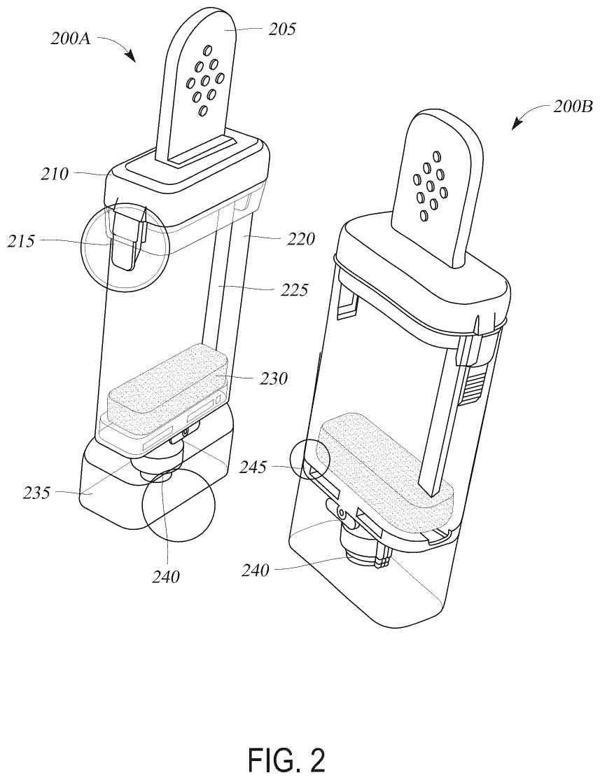

FIG. 2 illustrates perspective views of another example of an open system contaminant collection device, with two such devices 200A, 200B shown. Each device 200A, 200B can include a swab 230 and a container 220 for scaling the swab 230 after collection of contaminant particles.

The swab 230 can be constructed from a material having desired pickup efficiency and shedding efficiency for detecting trace amounts of contaminants, for example antineoplastic agents. Examples of swab materials are discussed in more detail below. The swab 230 is provided on a handle 225 having sufficient length so that the user can swab a surface without physically contacting the surface or the swab 230. The swab 230 can be pivotably coupled to the handle 225 in some embodiments. The handle 225 can be coupled to or part of a cap 210 in some embodiments. As such, cap 210 can include a portion 205 extending from the body of the cap 210 for grasping by a user.

A liquid can be provided within the container 220 so that the user removes a pre-wetted swab to wipe the surface (and optionally pours additional liquid onto the surface from the container 220) in one implementation. In another implementation, the user can spray the surface with a liquid and collects this liquid with the swab.

After swabbing the surface, the user places the swab 230 into the container 220 and the cap 210 forms a liquid-tight seal when engaged with the container 220. The cap 210 can additionally lock to the container. As illustrated, cap 210 can include one or more tabs 215 that securely couple the cap 210 to the container 220 to provide a liquid-tight enclosure within the container 220. The tabs 215 can releasably engage corresponding features of the container 220 to both provide the liquid-tight seal and allow for removal and use as the handle of the swab 230. A base 235 of the container 220 can be shaped to allow the container 220 to stand upright on a surface, further preventing liquid spillage from container 220. The lower interior portion of the container 220 can include steps 245, wedges, or other structures along its interior to squeeze liquid from the swab 230 when inserted fully into the container 220. Thus, the length of handle 225 can be selected to force swab 230 onto the steps 245 when the cap 210 is coupled to the container 220.

The container 220 advantageously prevents liquid from spilling and contaminating surfaces or users, but provides for controlled release of liquid to a detection system. The detection system can include a test cartridge. Controlled release of the liquid can be provided through a release mechanism, such as valve 240. Valve 240 can be a one-way valve in some embodiments. In some embodiments, the body of the container 220 can be flexible to allow a user to squeeze liquid through the valve 240. In some embodiments, the base 235 of container 220 can be flexible to allow a user to squeeze the valve 240 open to allow liquid to drop through while keeping the hands of the user away from the liquid. In other embodiments the valve 240 can be incorporated into a coupling mechanism for coupling to a closed system detection device and the collection device 200A, 200B can be a closed system contaminant collection device as discussed in more detail below.

In some embodiments, a user can shake or otherwise agitate the collection devices shown in FIGS. 1A-2 prior to transferring the liquid to a detection device to release collected contaminants from the swab 125, 230 into the liquid in the container. For example, the container can be inverted a number of times to allow the liquid to flow back and forth across the material of the swab. The liquid can have properties that assist in releasing collected contaminants from the swab material in some implementations, as discussed in more detail below. As such, the flow of the liquid can extract the contamination from the material of the swab and mix it into a homogeneous solution for testing.

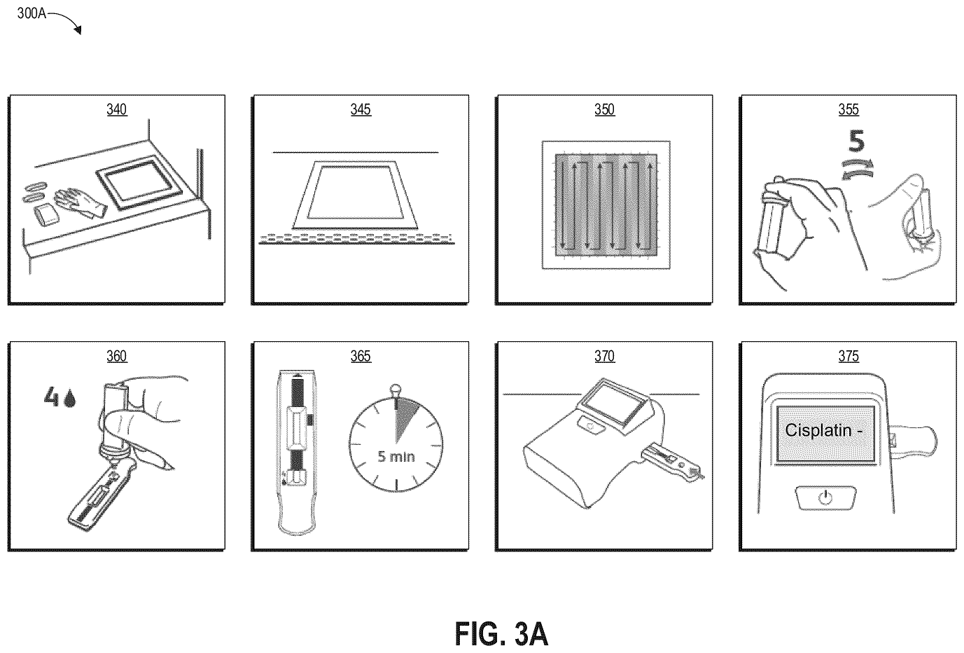

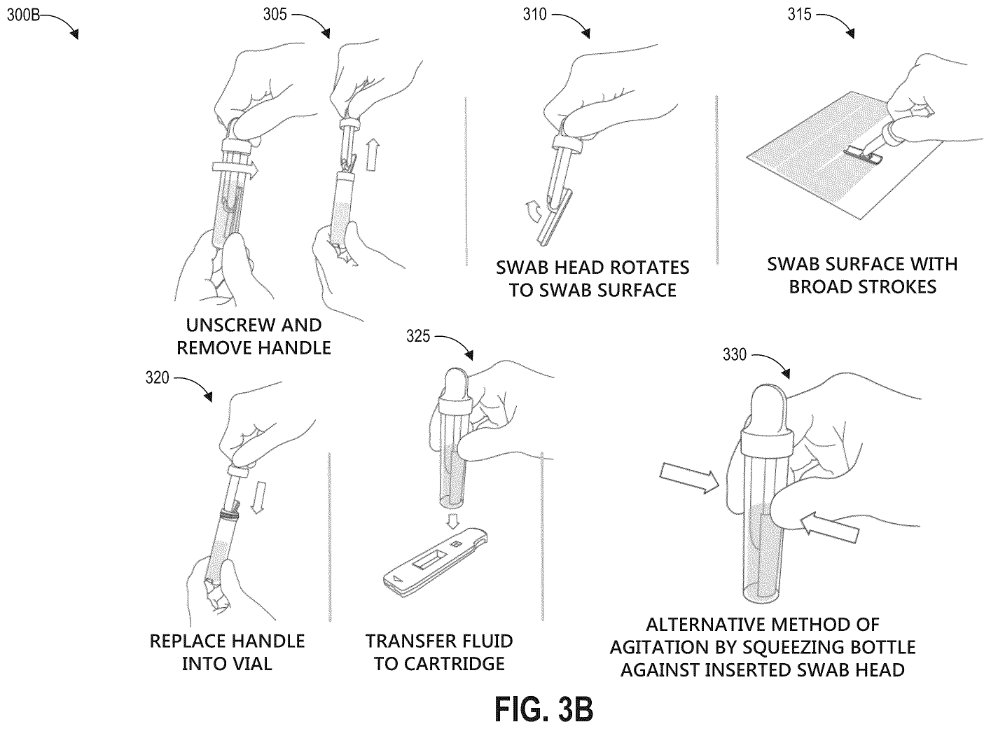

FIG. 3A illustrates example steps of a testing method 300A using an open system contaminant collection device, such as but not limited to those shown in FIGS. 1A-2. One, some, or all of the depicted blocks of FIG. 3A can be printed as graphical user interface instructions on the packaging of an assay and/or collection kit, for example the packaging shown in FIGS. 1N and 1O, or can be presented on a display screen of an assay reader device, a test area terminal, or a personal computing device of the user.

At block 340, the user can identify a sample location and gather a collection kit, test cartridges, and a template. The collection kit can be the kit 170 described above and can include container 130, top 115, and cap 105 assembled and containing liquid, and can include a sealed package with handle 120 and pre-moistened swab material 125. The collection kit can include a swab attached to a handle and a collection container. In some examples, the swab is pre-wetted with liquid and packaged together with the handle in a first sealed pouch and the collection container is packaged in a second sealed pouch. In some embodiments, the collection container includes a dye and a reducing agent. The test cartridge may include a window or port aligned with a sample receiving zone of the assay device. In one implementation, the test cartridge includes a dye and a reducing agent. Also at block 340 the user can put on clean gloves prior to each sample collection and/or opening of the collection kit, both to protect the user from potential contamination on the surface and to protect the collected sample from contamination on the user's hands.

At block 345, the user can establish a test area on the test surface. For example, the user can place a template (physical or augmented reality) over the intended location to clearly demarcate the area that will be swabbed. Also at block 345 the user can open the collection kit packaging, including opening the separately-packaged swab and handle. The test area may be one square foot in some embodiments, for example demarcated as a 12 inches by 12 inches (144 square inches) region. Other examples can use greater or smaller areas for collection including 10 inches by 10 inches, 8 inches by 8 inches, 6 inches by 6 inches and 4 inches by 4 inches, non-square rectangular regions (e.g., a 9 inches by 16 inches rectangle), and non-rectangular regions (e.g. circles). Different-sized templates may be specified for usage with different test surfaces. The particular template used can be indicated to a reader device, for example via a manual user input or via a barcode or other identifying pattern on the template scanned by the reader device. For example, a template providing a swab area of a 12 inches by 12 inches region can be indicated for use in sampling a countertop, while a smaller template demarcating a smaller swab area can be indicated for swabbing an IV pole. The reader device can adjust its test result calculations to account for the actual area tested, as indicated by the particular template used for the sampling procedure.

At block 350, the user can swab the entire test area with the pre-moistened swab. The user can swab the test area using slow and firm strokes. As shown, the user can methodically pass the swab in straight lines along the height of the test area all the way across the width of the test area.

At block 355, the user can insert the swab into the collection container. In some examples, the collection container includes a t-shaped well. Though not illustrated, the swab may have a t-shaped cross-section that substantially matches that of the container well. The user seals the container with a top that includes a dripper cap, and fully inverts (e.g., turn upside down and then return to right-side-up) the sealed container five times. During these inversions, the liquid in the well of the container washes primarily over the swab material due to the cross-sectional shape and other features of the well, and the handle slides within the well due to the well having a greater height than the handle. As described herein, the inversion combined with the geometries of the container and handle and the flow of the liquid can extract collected contaminants from the swab material. In one non-limiting example, the user does not invert or agitate the container before moving to the next step. If the dye and reducing agent is included in the collection container, the user may be instructed to let the collection container sit for a prescribed period of time before proceeding to the next step.

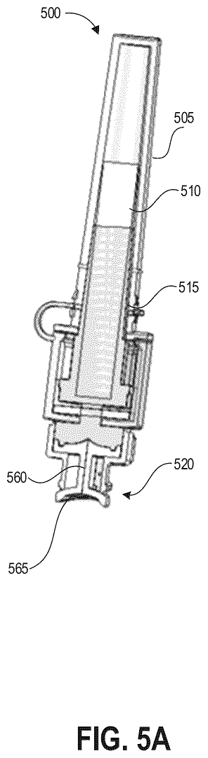

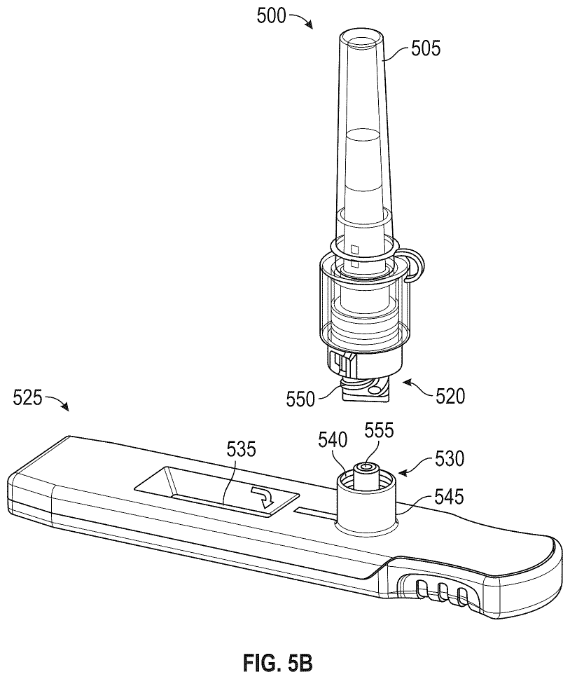

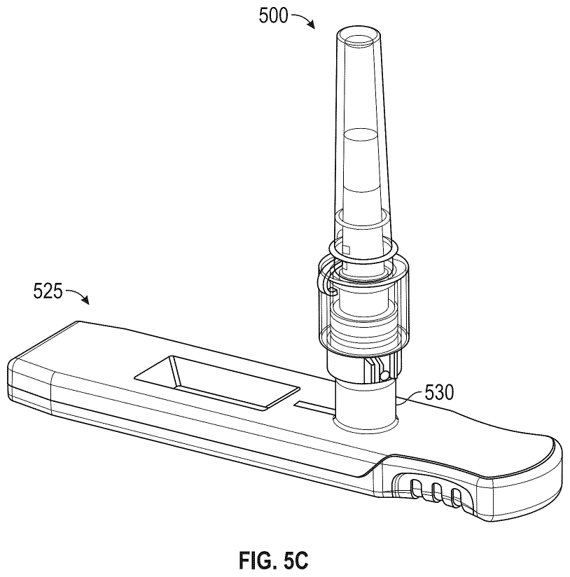

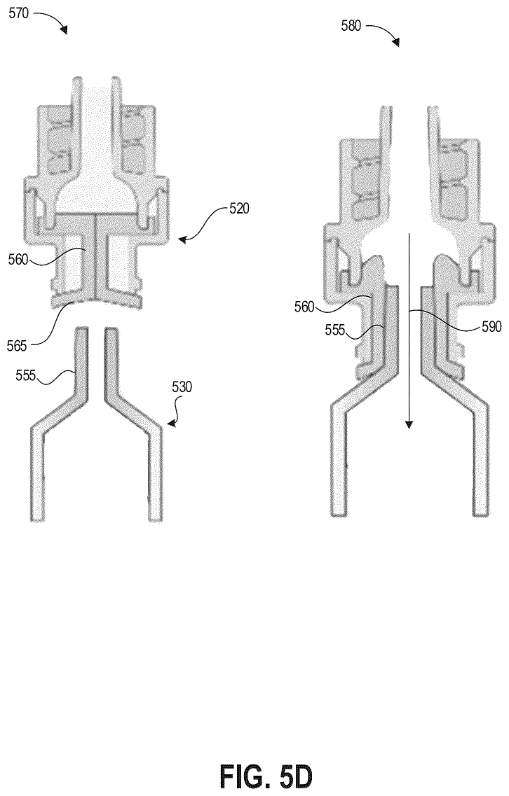

At block 360, the user can leave the swab and handle inside the container, remove the dripper cap, and squeeze (or allow gravity to draw) one or more drops (for example but not limited to four drops) into the sample well on one or more test cartridges. For example, in some embodiments the user may drop sample onto multiple assays each designed to test for a different drug. In some examples anywhere between three and ten drops can produce suitable results on the assay. In alternate embodiments the user may mechanically couple a liquid transfer portion of the collection device to a liquid transfer portion of the assay device to release a controlled volume of sample through a closed liquid pathway, for example as shown in FIG. 5C.

At block 365, the user can use a timer to allow the sample to develop for a period of time. For example, the sample can develop for about one minute, about two minutes, about three minutes, about four minutes, about five minutes, about six minutes, about 20 minutes, about 40 minutes, about 60 minutes, about 120 minutes, or some other amount of time. Other development times are possible. In some embodiments the timer can be built in to the programming of the reader device that reads the assay. The development time can vary depending on the particular test that is being performed and the particular operating parameters of the assay device.

At block 370, the user can insert the test cartridge into an assay reader device. The test cartridge can be inserted into the reader device prior to or after the sample is developed, depending upon the operational mode of the device. In some embodiments, the user may sequentially insert multiple cartridges for testing different aspects of the sample or for ensuring repeatability of test results.

At block 375, the assay reader device reads portions of the inserted cartridge (including, for example, detecting optical signals from a detection window in the cartridge), analyzes the signals to determine optical changes in the cartridge and optionally control zone location(s), determines a result based on the optical changes, and displays the result to the user. The device can optionally store the result or transmit the result over a network to a centralized data repository. As illustrated, the device displays a negative result for the presence of cisplatin in the sample. In other embodiments the device can display a specific detected concentration level in the sample and/or determined for the test area, and optionally can display confidence values in the determined result. In some embodiments, a series of measurements are taken over a period of time in order to measure a change in absorbance/color over time.

After testing the user can re-seal the container with the dripper cap and dispose of the collection device and assay (for example in compliance with hazardous waste regulations). Optionally, the user can reconnect the reader device to its power supply, execute any needed decontamination procedures, re-test a decontaminated surface, and perform required reporting of the result.

FIG. 3B illustrates another testing method 300B that depicts details of steps 350, 355, and 360 of the process 300A using an alternate embodiment of the collection device.

At step 305 the user can remove the handle and swab from the container. As described above, the swab can be pre-wetted for wetting the test surface with a liquid that helps lift contaminants from the test surface into the swab and/or the user can separately apply liquid to the test surface.

At step 310, optionally in some embodiments the swab head can rotate to assist in maintaining contact between the swab and the test surface.

At step 315, the user can swab a designated test area of the test surface. It can be preferable in some implementations to swab the entirety of the test area and only within the test area so as to generate an accurate measurement of the concentration of the contaminant, particularly for contaminants where small quantities per area are harmful to users. Swabbing the entirety of the test area and only within the test area can also generate an accurate measurement of the concentration of the contaminant in situations where a very small amount of contaminant is present. Even if the amount of contaminant detected is very small and not immediately harmful to persons in the immediate area, detection of contaminant in any amount can alert the user to a leak or unintended release of hazardous material. As such, some embodiments can include placing a guide or template over the test area to assist the user with swabbing only the test area.

At step 320, the user can replace the swab and handle into the collection container. Optionally, the user and/or structure of the container can agitate the swab to release collected contaminants into the liquid within container. For example, step 330 shows the user squeezing the sides of the container against the swab head.

At step 325, the user can transfer liquid to a cartridge or to another test device. For example, the user can drip liquid from the container into a sample receiving window in a test cartridge.

Though not illustrated, further steps can include inserting the cartridge into a reader device, operating the reader device to analyze the test cartridge, and viewing results of the test.

### Overview of Example Closed System Contaminant Collection Devices

Some embodiments of the contaminant collection device can be “closed,” referring to the transfer of liquid from the collection device to the detection device via a liquid-tight transfer mechanism. For example, the collection device and detection device (such as a test cartridge) can be structured to couple together to provide a liquid tight seal between the liquid-containing portion of the collection device and the test strip so that harmful liquids, drugs, or vapors are completely contained and not vented into the atmosphere and possibly creating additional harm to the user. Liquid-tight can refer to being liquid impermeable, gas or vapor impermeable, or both, depending upon the properties of the contaminant that the collection kit is designed to detect. Beneficially, this can provide protection to a user of the kit from the potential contaminants in the liquid of the collection device.

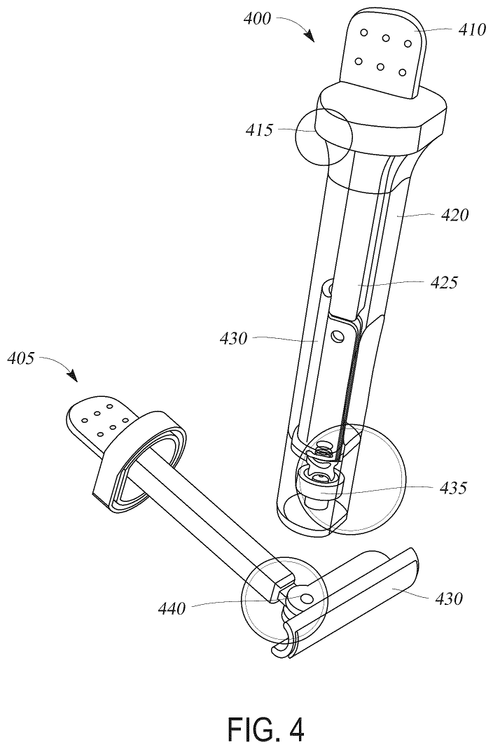

FIG. 4 illustrates an example of a closed system contaminant collection device 400. The collection device 400 can include a handle 405 that can be releasably coupled with container 420 to provide a liquid-tight enclosure. FIG. 4 shows the handle both coupled with container 420 and separate from container 420. Mechanisms to couple the handle 405 with the container 400 can include those described above with reference to FIGS. 1A-P, or other suitable mechanisms.

The handle 405 can include cap 415 and grasping tab 410 of cap 415, an elongate handle 425 extending from cap 415 to swab 430, swab 430, and a pivot 440. The swab 430 can be constructed from a material having desired pickup efficiency and shedding efficiency for detecting trace amounts of contaminants, examples of which are discussed in more detail below. Handle 425 can have sufficient length so that the user can swab a surface without physically contacting the surface or the swab 430. The swab 430 (or a base to which swab 430 is coupled) can be pivotably coupled to the handle 425 via pivot 440. The handle 425 can be coupled to or an integral part of the cap 415 in some embodiments. A user can hold the handle 405 by the tab 410 during wiping of a test surface.

A liquid, for example a liquid, can be provided within the container 420 so that the user removes a pre-wetted swab to wipe the surface (and optionally pours additional liquid onto the surface from the container 420) in one implementation. In another implementation, the user can spray the surface with a liquid and collects this liquid with the swab.

After swabbing the surface, the user places the swab 430 into the container 420 and the cap 415 forms a liquid-tight seal when engaged with the container 420. The cap 415 can additionally lock to the container.

The container 420 advantageously prevents liquid from spilling and contaminating surfaces or users, but provides for controlled release of liquid to a detection device. The detection device can be contamination test cartridge. Controlled release of the liquid can be provided through a release mechanism, such as valve 435, when the container 430 is coupled to a detection device. Thus, valve 435 can be incorporated into a coupling mechanism for coupling the collection device 400 to a portion of a detection device to create a closed liquid transfer system.

FIGS. 5A-5D illustrate another example of a closed system contaminant collection device 500 and an example of a closed system test cartridge 525. FIG. 5A illustrates a cut-away view of the collection device 500. FIG. 5B illustrates the collection device 500 and test cartridge 525 in a separated configuration. FIG. 5C illustrates the collection device 500 and test cartridge 525 in a coupled configuration. FIG. 5D illustrates an example set of liquid transfer couplings for providing a closed liquid path between the container 505 and test cartridge 525.

The collection device 500 includes a liquid-tight container 505 containing a volume of liquid 510 and swab 515. Collection device 500 further includes liquid transfer coupling 520 for providing a liquid-tight mechanical coupling to test cartridge 525 such that liquid can be transferred between the collection device 500 and the test cartridge 525 without escaping from the coupled closed system. A valve 560 of liquid transfer coupling 520 can be biased closed when the collection device 500 and test cartridge 525 are separated, and FIG. 5A shows the valve 560 in the closed position. The valve 560 can include a tapered or contoured lower surface 565. In some embodiments, the valve 560 can be a split septum valve, and in some embodiments valve 560 may be a mechanical valve.

The test cartridge 525 can be housed within a cartridge that includes coupling 530 for mechanically and fluidically coupling to the liquid transfer coupling 520 of the collection device 500. As illustrated, some implementations of the coupling 530 can include threads 540 along an interior of sleeve 545 for mechanically mating the coupling 530 with the threads 550 of the liquid transfer coupling 520. The coupling 530 can also include a nozzle 555 having an internal lumen for providing a fluidic pathway between the liquid transfer coupling 520 and the coupling 530. Nozzle 555 may be a male leur tip in some embodiments. The contoured or tapered lower surface 565 of liquid transfer coupling 520 may case connection with the nozzle 555 of the cartridge coupling 530 by guiding the nozzle 555 into the center of the liquid transfer coupling 520. In embodiments of the liquid transfer coupling 520 that implement a mechanical valve 560, a portion of the valve may open upon contact with the nozzle 555, either by displacement along the longitudinal axis of the liquid transfer coupling 520 or by radial displacement towards the circumferential edges of the liquid transfer coupling 520. In the open configuration, liquid flows through the valve 560 and into the nozzle 555.

As the collection device 500 is screwed into the coupling 530, the nozzle 555 can contact the lower surface 565 of the valve 560, thereby opening the valve 560 to release liquid into the nozzle 555. The liquid transfer coupling 520 can be a needleless connector, for example the MaxPlus™ needleless connector, MaxZero™ needleless connector, BD Q-Syte™ luer activated split septum, or SmartSite™ needle-free connectors available from Becton, Dickinson and Company (BD). Some embodiments of nozzle 555, container 510, and/or liquid transfer coupling 520 can be structured to allow only a controlled volume of liquid to pass, such as a volume suitable for flowing along the length of the test cartridge from a sample receiving zone to an analyte binding region 535 of the test cartridge. In some examples, the desired volume can include three to four drops of liquid. Nozzle 555 can be positioned to transfer liquid to the sample receiving zone of the cartridge.

As shown in FIG. 5C, when coupled the sleeve 545 of the coupling 530 surrounds the liquid transfer coupling 520. Some embodiments of sleeve 545 can optionally provide a liquid-tight seal with a lower portion of the container 510. In the configuration shown in FIG. 5C, a sealed liquid pathway is established between the container 510 and the sample receiving zone of the assay test cartridge via the mated container liquid transfer coupling 520 and cartridge coupling 530.

FIG. 5D illustrates cross-sections of one example of suitable closed-path liquid transfer couplings in uncoupled 570 and coupled 580 states. The cartridge coupling 530 is illustrated at a high level without the sleeve 545 or threads 540. As illustrated, in the uncoupled state 570 the valve 560 is closed and the nozzle 555 (e.g., a male luer tip) approaches the contoured or tapered lower surface 565. In the uncoupled state 570 the valve 560 extends across the entire cross-section of the liquid transfer coupling 520, preventing egress of any liquid from the container 505. Pushing the nozzle 555 into the valve 560 (for example by threading the liquid transfer coupling 520 and coupling 530 into the configuration of FIG. 5C) forces the valve 560 to open around the nozzle 555, thereby establishing an enclosed liquid path 590 from the container 505 through the lumen of the nozzle 555. The illustrated valve 560 is made from a flexible material that enables it to deform around the nozzle 555. Upon removal of the nozzle 555, the valve 560 automatically returns to the closed position shown in the uncoupled state 570, closing the liquid pathway and preventing spillage of potentially contaminated liquid from the container 505. The couplings shown in FIG. 5D can be incorporated into any of the collection devices shown herein, for example into the nozzle 110 of the container 130.

In some embodiments, a user can shake or otherwise agitate the collection devices shown in FIGS. 4 and 5A-5C prior to transferring the liquid to a detection device in order to release collected contaminants from the swab into the liquid in the container. For example, the container can be inverted a number of times to allow the liquid to flow back and forth across the material of the swab. The liquid can have properties that assist in releasing collected contaminants from the swab material in some implementations, as discussed in more detail below. As such, the flow of the liquid can extract the contamination from the material of the swab and mix it into a homogeneous solution for testing.

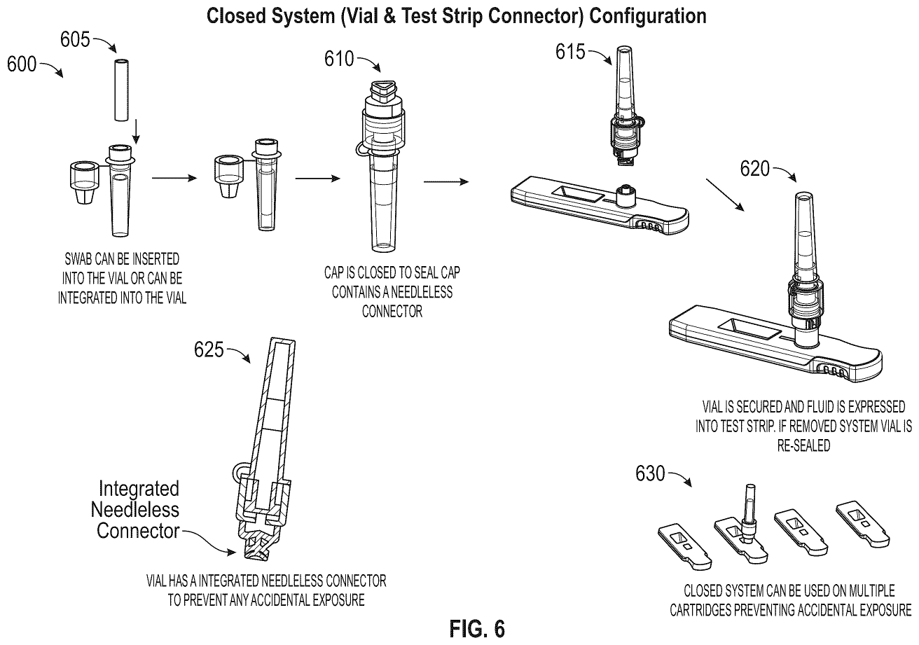

FIG. 6 illustrates example steps of a testing method 600 using a closed system contaminant collection device and closed system detection device, such as those described above with respect to FIGS. 4 and 5A-5C.

At step 605, a swab can be inserted into the vial. In some embodiments the swab can be integrated into a vial. The vial can be for example, the container 420 illustrated in FIG. 4, the liquid-tight container 505 illustrated in FIG. 5, or another suitable structure.

At step 610, a cap can be closed to seal the vial. The cap can include a needleless connector or other closed liquid transfer mechanism as described above.

At step 615, the vial can be inverted above a test cartridge. Because the vial is liquid-tight, no liquid escapes from the vial during inversion.

At step 620, the vial is coupled, mechanically and fluidically, to the closed system detection device, in this non-limiting example a test cartridge. A volume of liquid can be expressed from the vial onto a sample receiving zone of the test cartridge.

At step 625, the vial is removed from the test cartridge and the integrated needleless connector re-closes and re-seals to prevent liquid from escaping from the closed system contaminant collection device.

Optionally, as shown at step 630, the vial can be disconnected from the test cartridge to allow the vial to be coupled to additional test cartridges using the original collected sample. Advantageously, in some embodiments a test kit can include multiple test cartridges for testing for different contaminants and/or different concentrations of the same contaminant.

### Overview of Example Assay Reader Devices and Operations

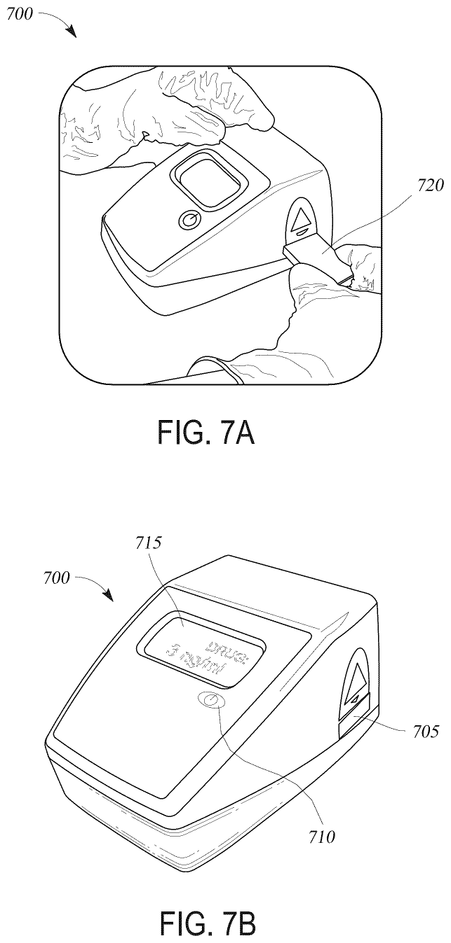

FIGS. 7A and 7B illustrate an example testing device 700 that can be included in or used with hazardous contamination detection kits described herein. FIG. 7A illustrates the testing device 700 with a test cartridge 720 inserted into the cartridge receiving aperture 705, and FIG. 7B illustrates the testing device 700 without an inserted cartridge. Examples of the test cartridge 720 include but are not limited to the test cartridge 145 illustrated in FIG. 1A, the test cartridge illustrated in FIGS. 3A and 3B, the test cartridge 525 illustrated in FIGS. 5B and 5C, and the test cartridges 630 illustrated in FIG. 6.

The testing device 700 can be an assay reader device having an aperture 705 for receiving an assay test cartridge 720 and positioning the test cartridge so that a detection window is positioned in the optical path of imaging components located inside of the device 700. The device can also use these or additional imaging components to image a bar code on the cartridge, for example to identify which imaging techniques and analysis to perform.

Some embodiments of the device 700 can be configured to perform an initial scan, for example using a bar code scanner to image one or more bar codes. A bar code can identify the type of test to be performed, the person conducting the test, the location of the test, and/or the location in the facility of the test surface (for example pharmacy, nursing area, cabinet #, bed #, chair #, pump #, etc.). After reading the bar code identifier the cartridge is then inserted into the reader as shown in FIG. 7A.

The device 700 can have a button 710 that readies the device for use and provides an input mechanism for a user to operate the device. In some embodiments device operation mode can be set via a number or pattern of clicks of the single button 710 of the device 700. For example, in some implementations a single press of the button 710 can power on the device 700 and set the device 700 to a default operation mode, and the device 700 can implement the default operation mode upon insertion of a cartridge. A double-click of the button 710 can initiate an alternate operation mode that is different than the default operation mode. Other numbers or patterns of pressing the single button 710 by a user can provide instructions to the processor of the device regarding a desired operation mode. Embodiments of a device 700 are described herein with reference to a single button, but other features allowing a user to select and switch between device operation modes are possible (such as but not limited to a single switch, knob, lever, or handle).

One example of a device operation mode is end-point read mode. In the end-point read mode, the user prepares and incubates the assay outside of the device 700 and tracks the development time of the assay. For example, an assay for determining cisplatin concentration can have a development time of, or of about, 2, 5, 10, 15 or more minutes, so the user would apply the liquid to the assay from a collection device as described herein and wait for 5 minutes. At the end of the 5 minutes the user would insert the assay 720 into the device 700 to obtain a test result. Accordingly, when operating in end-point read mode the device 700 can provide instructions, for example audibly or on a visual display, that instruct a user to wait for a predetermined time after applying a sample to an assay before inserting the assay in the device 700. In other embodiments, when operating in end-point read mode the device 700 may not display any instructions but may simply read an assay upon insertion into the device 700. Upon insertion of the assay into the base device 700, an optical reader of the device can collect data (for example, image data) representing the assay for analysis in determining a result of the assay. In some embodiments end-point read mode can be the default operation mode of the device 700.

Another example of a device operation mode is walkaway mode. When operating in walkaway mode, the device 700 can provide instructions for the user to insert the assay immediately after or during application of the sample. In the walkaway mode according to one embodiment, the user can apply the specimen to the assay and immediately insert the assay into the device 700. The assay will develop inside the device 700 and the device 700 can keep track of the time elapsed since insertion of the assay 720. At the end of the predetermined development time, the device 700 can collect data (for example, image data) representing the assay. In implementations where the device 700 is an imaging reader, the device 700 can analyze the image data to determine a test result, and report the test result to the user. The assay development time can be unique to each test. In some embodiments walkaway mode can be set by double-clicking the single button 710 of the device 700. Further input can indicate the assay development time to the reader device. For example, a barcode scanned by a barcode reader, or a barcode provided on the assay or on a cartridge used to hold the assay, can indicate to the device 700 a type of assay that is inserted and a development time for that assay. Based upon the type of assay, the device 700 can wait for the predetermined amount of time after sample application and insertion before collecting image data representing the assay.

There are many advantages associated with the ability of a user to select and switch between device operation modes in implementations of base assay analyzers described herein. The endpoint read mode can be convenient in large laboratories or medical practice facilities where personnel typically batch process a number of tests. The walkaway mode can be useful when a single test is being performed, or when the end user does not want to have to track the assay development time (or is not knowledgeable or not trained on how to track the assay development time accurately). The walkaway mode can advantageously reduce or eliminate the occurrence of incorrect test results due to an assay being inserted and read (for example, imaged) too quickly (too soon before the development time of the assay has elapsed) or too slowly (too long after the development time of the assay has elapsed). Further, in walkaway mode the assay reader can operate to capture multiple images of the assay at predetermined time intervals, for example when a kinetic graph of the assay readings is desired.

One embodiment of the disclosed device 700 includes only a single button 710 on its exterior housing, such as a single power button that powers the device 700 off and on. Embodiments of the disclosed device 700 also implement two different device operation modes (although more than two device operation modes are possible). In order to enable the end user to select and switch between the two device operation modes, the device 700 can include instructions to implement a double-click function on the power button. After receiving input of a single press of the button to power on the device, insertion of an assay cartridge can automatically trigger end-point read mode. When the processor of the device receives input from a user double-clicking the power button, this can initiate the stored instructions to implement the walkaway mode. This double-click functionality offers a simple and intuitive way for the end user to switch between different operation modes of the base assay analyzer. The double-click functionality also enables the user to configure the device in real time to operate in the walkaway mode without requiring any additional configuration steps or additional programming of the device 700 by the user. It will be appreciated that the device 700 can be provided with instructions to recognize other click modes instead of or in addition to the double-click to trigger secondary (non-default) device operation modes, for example to recognize a user pressing the button any predetermined number of times, pressing the button in a predetermined pattern, and/or pressing and holding the button for a predetermined length of time.

The device 700 can also include a display 715 for displaying instructions and/or test results to the user. After insertion of the test cartridge, the device 700 can read a bar code on the assay test cartridge to identify the name and/or concentration range of the drug. The device 700 can image the inserted test cartridge, and analyze the signals representing the imaged test cartridge to calculate results, display the results to the user, and optionally transmit and/or locally store the results. The results can be calculated and displayed as contamination with an indication of positive or negative (for example, +/−; yes/no; etc.), and/or the actual contamination per area (for example, Drug Concentration=0.1 ng/cm2) and/or per volume (for example, Drug Concentration=3 ng/ml)

Some embodiments of the device 700 may simply display the result(s) to the user. Some embodiments of the device 700 may also store the result(s) in an internal memory that can be recalled, for example, by USB connection, network connection (wired or wireless), cell phone connection, near field communication, Bluetooth connection, and the like. The result(s) can also automatically be logged into the facility records and tracking system. The device 700 can also be programmed to automatically alert any additional personnel as required, without further input or instruction by the user. For example, if the device 700 reads contamination levels that are above the threshold of human uptake and considered hazardous to for human contact, a head pharmacist, nurse, manager, or safety officer can be automatically notified with the results and concentration of contamination to facilitate a rapid response. The notification can include location information, such as but not limited to a geographic position (latitude/longitude) or description of location (Hospital A, Patient Room B, etc.). That response may include a detailed decontamination routine by trained personnel or using a decontamination kit provided together or separately from the hazardous contamination detection kit.

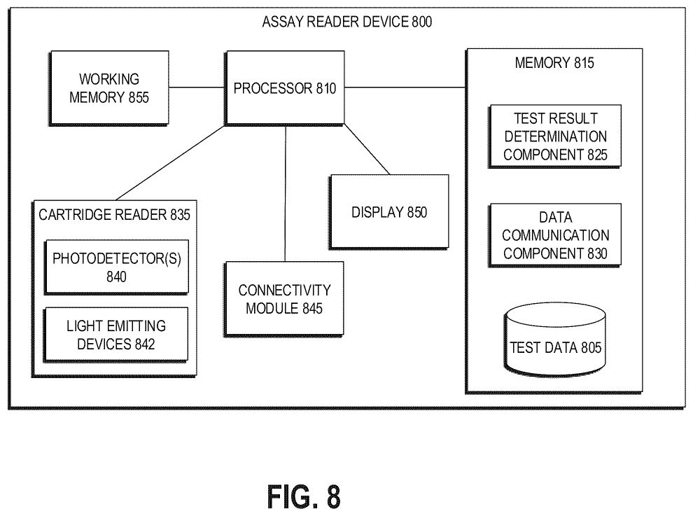

In some embodiments, device 700 can be a special-purpose assay reader device configured with computer-executable instructions for identifying trace concentrations of contaminants in the samples applied to test cartridges. Further components of the device 700 are discussed below with respect to the diagram of FIG. 8.

FIG. 8 illustrates a schematic block diagram of one possible embodiment of components of an example assay reader device 800. The components can include a processor 810 linked to and in electronic communication with a memory 815, working memory 855, cartridge reader 835, connectivity module interface 845, and display 850.

Connectivity module 845 can include electronic components for wired and/or wireless communications with other devices. For example, connectivity module 845 can include a wireless connection such as a cellular modem, satellite connection, or Wi-Fi, or via a wired connection. Thus, with connectivity module 845 the assay reader device can be capable of sending or uploading data to a remote repository via a network and/or receiving data from the remote repository. As such, the test data of such assay reader devices can be stored and analyzed, alone or in the aggregate, by remote devices or personnel. A module having a cellular or satellite modem provides a built-in mechanism for accessing publicly available networks, such as telephone or cellular networks, to enable direct communication by the assay reader device with network elements or other testing devices to enable electronic test result transmission, storage, analysis and/or dissemination without requiring separate intervention or action by the user of the device. In some embodiments connectivity module 845 can provide connection to a cloud database, for example a server-based data store. The cloud based connectivity module can enable ubiquitous connectivity of assay reader devices without the need for a localized network infrastructure.

The cartridge reader 835 can include one or more photodetectors 840 for reading an assay held in an inserted cartridge and optionally any information on the inserted cartridge, for example a barcode printed on the cartridge, and one or more light emitting devices 842 for illuminating the inserted cartridge at one or more wavelengths of light. The cartridge reader 835 can send image data from the one or more photodetectors to the processor 810 for analysis of the image data representing the imaged assay to determine a test result of the assay. The cartridge reader 835 can further send image data from the one or more photodetectors representing the imaged cartridge for use in determining which one of a number of automated operating processes to implement for imaging the assay and/or analyzing the image data of the assay. The photodetector(s) 840 can be any device suitable for generating electric signals representing incident light, for example a PIN diode or array of PIN diodes, a charge-coupled device (CCD), or a complementary metal oxide semiconductor (CMOS) sensor, to name a few examples. The cartridge reader 835 can also include a component for detecting cartridge insertion, for example a mechanical button, electromagnetic sensor, or other cartridge sensing device. An indication from this component can instruct the processor 810 to begin an automated assay reading process without any further input or instructions from the user of the device 800.

Processor 810 can be configured to perform various processing operations on image data received from the cartridge reader 835 and/or connectivity module interface 845 in order to determine and store test result data, as will be described in more detail below. Processor 810 may be a general purpose processing unit implementing assay analysis functions or a processor specially designed for assay imaging and analysis applications. The processor 810 can be a microcontroller, a microprocessor, or ASIC, to name a few examples, and may comprise a plurality of processors in some embodiments.

As shown, the processor 810 is connected to a memory 815 and a working memory 855. In the illustrated embodiment, the memory 815 stores test result determination component 825, data communication component 830, and test data repository 805. These modules include instructions that configure the processor 810 of device 800 to perform various module interfacing, image processing, and device management tasks. Working memory 855 may be used by processor 810 to store a working set of processor instructions contained in the modules of memory 815. Alternatively, working memory 855 may also be used by processor 810 to store dynamic data created during the operation of device 800.

As mentioned above, the processor 810 may be configured by several modules stored in the memory 815. The test result determination component 825 can include instructions that call subroutines to configure the processor 810 to analyze assay image data received from the photodetector(s) 840 to determine a result of the assay. For example, the processor can compare image data to a number of templates or pre-identified patterns to determine the test result. In some implementations, test result determination component 825 can configure the processor 810 to implement adaptive read processes on image data from the photodetector(s) 840 to improve specificity of test results and to reduce false-positive results by compensating for background and non-specific binding.

The data communication component 830 can determine whether a network connection is available and can manage transmission of test result data to determined personnel and/or remote databases. If the device 800 is not presently part of a network, the data communication component 830 can cause local storage of test results and associated information in the test data repository 805. In some case, the device 800 can be instructed to or automatically transmit the stored test results upon connection to a network. If a local wired or wireless connection is established between the device 800 and another computing device, for example a hospital, clinician, or patient computer, the data communication component 830 can prompt a user of the device 800 to provide a password in order to access the data in the repository 805.

The processor 810 can be configured to control the display 850 to display captured image data, imaged barcodes, test results, and user instructions, for example. The display 850 may include a panel display, for example, an LCD screen, LED screen, or other display technologies, and may implement touch sensitive technologies.

Processor 810 may write data to data repository 805, for example data representing captured images of assays, instructions or information associated with imaged assays, and determined test results. While data repository 805 is represented graphically as a traditional disk device, those with skill in the art would understand that the data repository 805 may be configured as any storage media device. For example, data repository 805 may include a disk drive, such as a hard disk drive, optical disk drive or magneto-optical disk drive, or a solid state memory such as a FLASH memory, RAM, ROM, and/or EEPROM. The data repository 805 can also include multiple memory units, and any one of the memory units may be configured to be within the assay reader device 800, or may be external to the device 800. For example, the data repository 805 may include a ROM memory containing system program instructions stored within the assay reader device 800. The data repository 805 may also include memory cards or high speed memories configured to store captured images which may be removable from the device 800.

Although FIG. 8 depicts a device having separate components to include a processor, cartridge reader, connectivity module, and memory, one skilled in the art would recognize that these separate components may be combined in a variety of ways to achieve particular design objectives. For example, in an alternative embodiment, the memory components may be combined with processor components to save cost and improve performance.

Additionally, although FIG. 8 illustrates a number of memory components, including memory 815 comprising several modules and a separate memory 855 comprising a working memory, one of skill in the art would recognize several embodiments utilizing different memory architectures. For example, a design may utilize ROM or static RAM memory, internal memory of the device, and/or an external memory (e.g., a USB drive) for the storage of processor instructions implementing the modules contained in memory 815. The processor instructions may be loaded into RAM to facilitate execution by the processor 810. For example, working memory 855 may comprise RAM memory, with instructions loaded into working memory 855 before execution by the processor 810.

### Overview of Further Examples of Contaminant Collection Devices

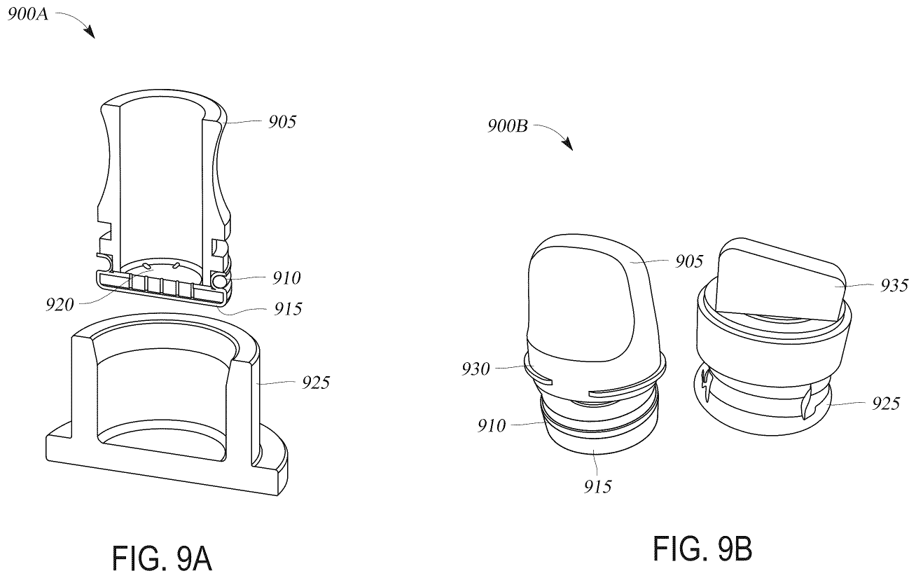

FIGS. 9A and 9B illustrate examples of a contaminant collection device 900A, 900B that can be used in hazardous contamination detection kits described herein. FIG. 9A illustrates a cross-sectional view of a first embodiment of the collection device 900A with a handle 905 removed from a container 925. FIG. 9B illustrates another embodiment of the collection device 900B with the handle 905 removed from the container 925 and a cap 935 in the container 925.

The collection device 900A, 900B includes a swab 915 attached to a handle 905 that allows the user to wipe the surface to be tested by holding only the handle 905 and not contacting the surface. After wiping the surface, the handle is inserted into a container 925 with additional liquid (not illustrated). When the handle 905 is inserted into the container 925, the sides of the handle seal with the interior of the container, for example by O-ring 910. As the handle approaches the bottom of the container, either by simply pressing or with the assistance of a threaded engagement between the handle 905 and the container 925, the liquid is pressurized and forced through the swab fabric, through small holes 920 in the handle, and into the handle interior. Partial removal of the handle can create a vacuum, sucking the liquid back through the swab fabric again. Repeating this process multiple times helps to flush the collected contaminations from the fabric creating a homogeneous solution. The structure of the collection device 900A, 900B positively forces the liquid through the fabric as a means of extracting the contamination from the fabric.

A needleless connection system, such as that discussed above with respect to FIGS. 5A-5C, can be incorporated into the handle 905 to allow for the closed transfer of liquid from the interior of the handle to a test device. The embodiment 900A of FIG. 9A does not show a needleless connection system. The embodiment 900B of FIG. 9B includes threads 930 to assist in the creation of the pressure and vacuum as well as an attachment point for the needleless connector. FIG. 9B also shows a cap 935 for the container 925 to contain the liquid until use.

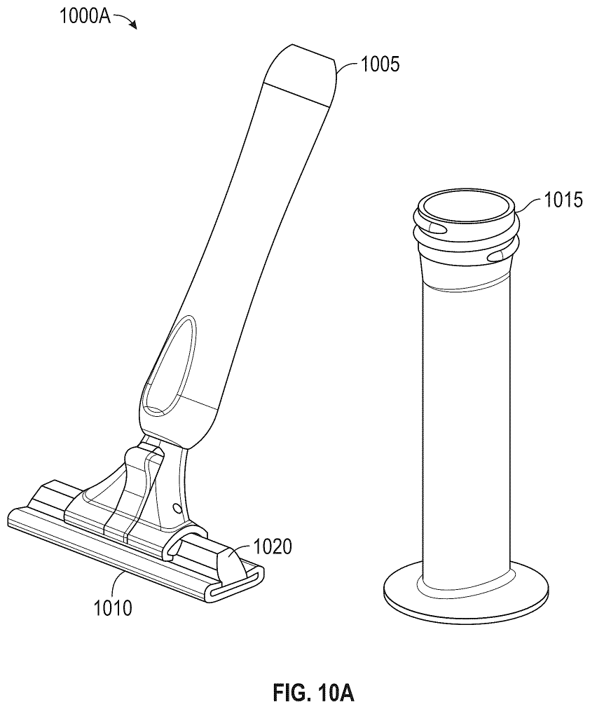

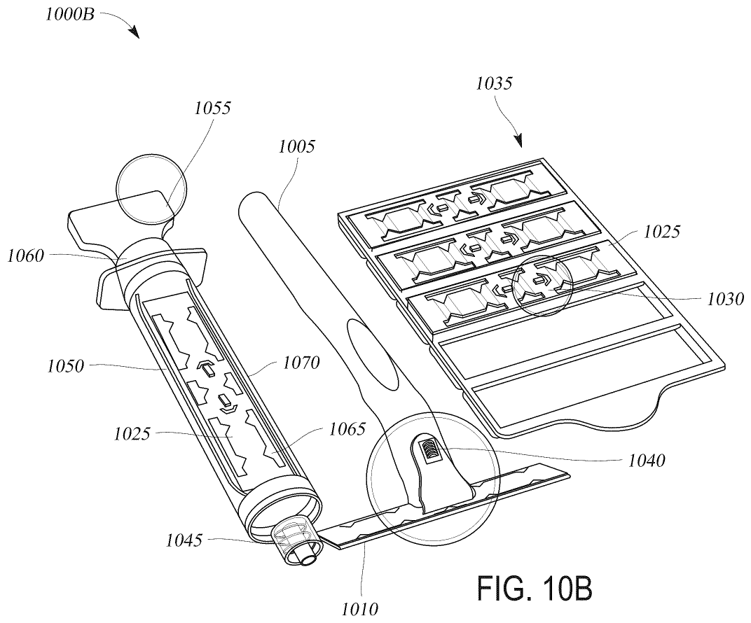

FIG. 10A illustrates another example of a contaminant collection device 1000A that can be used in hazardous contamination detection kits described herein. In this embodiment, a swab material 1010 is attached to a detachable base 1020 of a handle 1005, which is then attached to the handle 1005 using a releasable attachment mechanism similar to a razor handle. After the user swabs a surface (using a motion similar to using a razor to shave), the swab base 1020 can be disconnected from the handle 1005 and dropped into a container 1015 containing a liquid. The container can be capped and then inverted a number of times to flow the liquid back and forth across the swab 1010 to extract any contaminants. The container 1015 can include an interior portion shaped to correspond to the shape and size of the swab 1010, similar to the FIGS. 1A-1L configuration. In one example where device 1000A is a closed system contaminant collection device, the container 1015 may contain a needleless connection system as described above, either in the bottom of container 1015 or as part of a cap (not shown), in order to transfer the liquid to a test device. In another example where device 1000A is an open system contaminant collection device, the cap may also contain an orifice that allows for single drops of the liquid to be dripped out of the container into the test cartridge.

FIG. 10B illustrates another example of a contaminant collection device 1000B that can be used in hazardous contamination detection kits described herein. Similar to collection device 1000A, collection device 1000B includes a swab material 1010 attached to a handle 1005. A tray 1035 having a number of swab cartridges 1025 can be provided with the handle 1005. Each cartridge 1025 can secure a swab material to a first surface, and a second surface opposing the first surface can include an attachment device 1030 for releasably attaching to the handle 1005. As illustrated, attachment device 1030 can be a pair of prongs, or in other embodiments can be any suitable structure for press-fitting, snapping, hook-and-eye latching, or otherwise attaching to the handle. Handle 1005 can be provided with a release mechanism 1040, for example a button or lever, so that the user can release the cartridge 1025 and attached swab 1010 without contacting the swab 1010.

The contaminant collection device 1000B of FIG. 10B also includes a closed liquid transfer system 1050 for containing a used swab cartridge 1025 and attached swab 1010 between wiping the test surface and performing a test to analyze the sample. The closed liquid transfer system 1050 can include a handle 1060 having a grip portion 1055 and a cartridge well 1065 spaced away from the grip portion 1055 for securing a used cartridge 1025 away from the fingers of a user. The handle 1060 can be inserted into a liquid-tight container 1070 that sealingly engages the handle to prevent escape of enclosed liquids. The closed liquid transfer system 1050 can further include a liquid-tight liquid transfer mechanism 1045 in some embodiments, for example a needleless connector as described above, for transferring the enclosed liquid to a test device. Liquid can be expelled from the liquid-tight container 1070 in some embodiments by the user pressing or twisting the grip portion 1055 to compress or wring the enclosed cartridge 1025.

FIG. 11 illustrates an example of a pivoting collection device swab 1100 that can be used in hazardous contamination detection kits described herein. A handle 1110 includes a grip portion 1105, an elongate swab handle 1115 having a pivot 1120 connected to a swab head 1125, and a swab 1130. Such a pivoting head can be used, in some examples, in the collection device 400 described above.

The benefits of a pivoting head are two-fold. First, the pivoting head enables the user to have access to a large swab head reducing the need for multiple passes when swabbing the potentially contaminated surfaces. Second, the pivoting head creates a compact swab handle/vial system when the handle is inserted into the liquid vial enabling a minimal amount of liquid required as well as requiring minimal storage space. The liquid vial (not shown, see FIG. 4 for an example) can also be designed to be long and slender and interact with the swab-head such that when the swab-head handle is inserted into the liquid vessel it will serve to agitate the swab material facilitating a more efficient release of the collected sample into the liquid material. This can be accomplished via a snug-fit as well as internal geometry (ribbing, bumps, bottle-neck, etc.) to compress/agitate the swab 1130 when the handle is inserted into the container. A variation on the design is to mold the vial out of a softer compliant plastic allowing the user to squeeze the tube against the inserted swab head facilitating a greater release of sample from the swab head.

The pivoting joint 1120 that connects the swab head to the handle can be located anywhere along the swab head. Another aspect of this embodiments involves moving the pivoting location away from the center toward one end of the swab head 125. This can cause the swab head to rotate from the horizontal wiping/sampling position into a more vertical position to more easily present the swab head into the more compact vial. This also has the advantage that any residual liquid would pool up at the distal end of the swab head when it is rotated and drip into the vial, as opposed to dripping on the table or sampling surface. Reducing lost volume of captured liquid and drug is also beneficial for more accurate sampling results. In the illustrated embodiment, the preferred position of the pivoting joint ranges from about 25% to 75% of the distance from the center of the swab/wipe head to the end of the swab head. This can provide enough stability when wiping and an increased tipping moment when lifted from the surface and presented at the vial to complete the remainder of the process.

When pressed against the surface to be swabbed, the swab head 1125 complies in a rotating motion to lay flat against the surface, thereby providing contact between a larger surface area of the swab material and the test surface compared to non-pivoting embodiments that may be positioned at an angle to the test surface. Upon completion of swabbing, the handle can be inserted into the vial and the swab head can rotate in-line axially with the handle, enabling it to slide into a slender liquid vial. The insertion of the handle into the liquid vial can simultaneously agitate the swab material to express out both diluent and collected sample substances into the vial.

The embodiment of FIG. 11 can provide several advantages: 1) a larger swab-head surface reducing the number of passes along the surface that would be required to collect the sample, 2) a matching vial which can continue to be slender and compact reducing the need for a large amount of diluent, and 3) providing a more robust handle configuration so the user can press against the surface with an adequate amount of pressure (test results indicate that pressure and friction are the leading success factors to obtaining an adequate amount of substances from the surface).

An example of using the swab 1100 of FIG. 11 is shown in FIGS. 3A and 3B.

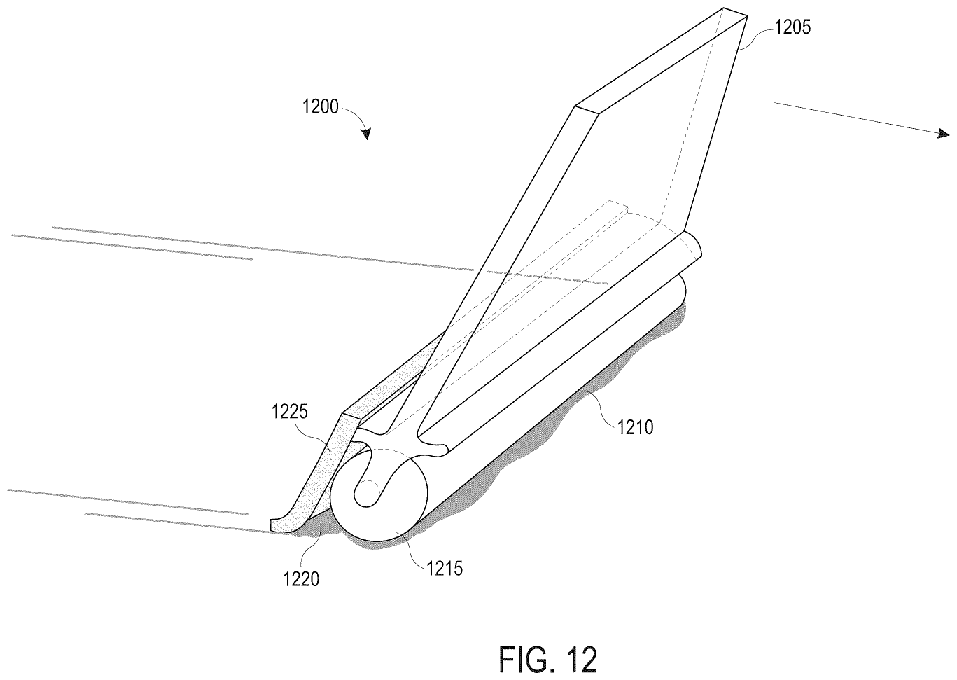

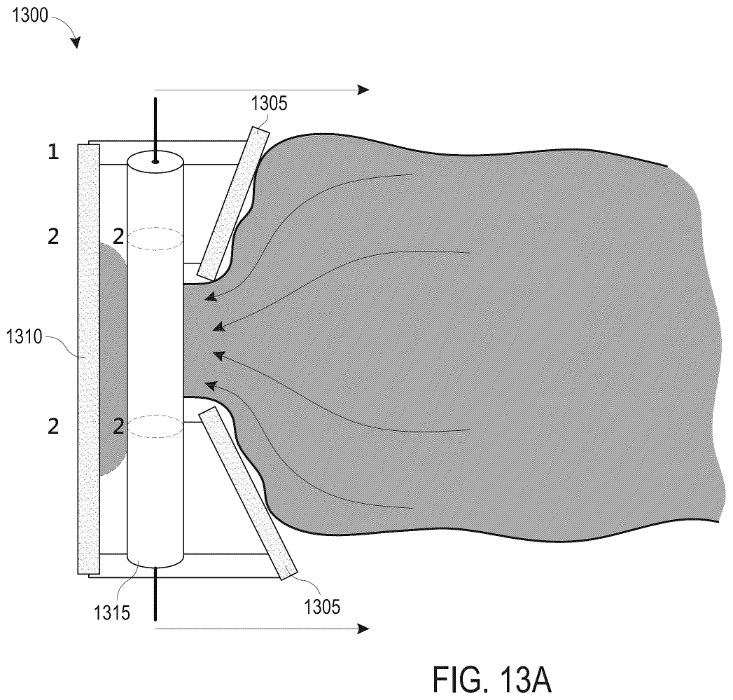

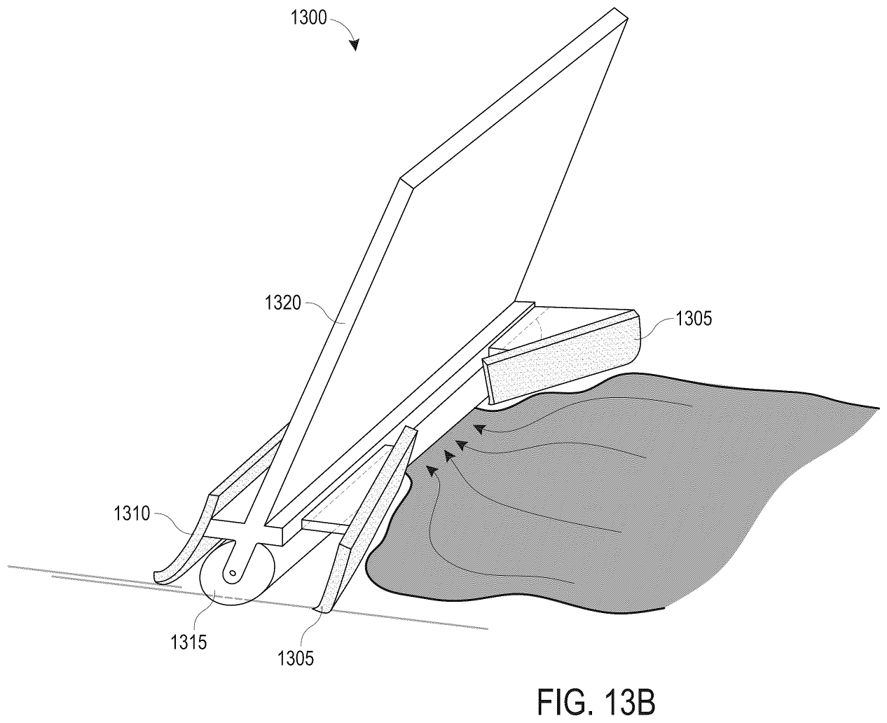

Contamination collection devices described herein can be designed to improve the efficiency terms of the concentration equation above, for example as illustrated in FIGS. 12 and 13A-13B. If the pick-up efficiency level can be increased, and the variation in pick up efficiency can be lowered, then efficiency can be increased to its highest possible level (with low variability) and the determined concentration will be more accurate. If the pick-up efficiency is too low the result would be a false negative result to the end user. If the user thinks that their collection kit picked up all of the drug on the contaminated surface for testing but in reality it did not, then contamination would remain on the test surface, and the reader would read a value that is lower than it should be. This lower value could lead to a false reading, and individuals in the contaminated environment could be exposed to possibly more hazardous values.

The embodiments of FIGS. 12 and 13A-13B reduce the number of collection steps by utilizing and combining two technologies in the pick-up process. A swab can be used to dispense liquid onto the test surface, then a squeegee can be used to collect the liquid and wiped solution and concentrate it into a pool for the swab to re-absorb. The combination of these two elements integrated in the same device in close proximity can simplify the workflow of wetting and wiping the wetted surface. As a result of having a combined squeegee feature directly behind or in close proximity to the swab, the squeegee feature wipes the surface and the swab is in such close proximity that it automatically re-absorbs the liquid.

The friction and pressure generated by the squeegee can leave a potentially contaminated surface more “clean” from contaminants than it was prior to testing by wiping and concentrating the contaminated drug and providing the solution in close proximity to the swab for pick-up. The use of the squeegee and swab together can allow the user to use fewer steps in the collection and wiping process and provide higher pick-up efficiencies with lower variation.

FIG. 12 illustrates an example of a squeegee collection device 1200 that can be used in hazardous contamination detection kits described herein. The squeegee collection device 1200 includes a handle 1205, a swab 1210 coupled to one end of the handle, and a squeegee 1225 that trails behind the swab 1210 when wiped across a surface in order to collect liquid 1220 not initially picked up by the swab between the squeegee 1225 and swab 1210. The handle 1205 can be held by a user manually operating the squeegee collection device 1200 in some embodiments. In other embodiments, handle 1205 can be modified or omitted in order to couple the squeegee collection device 1200 to an automated system for wiping a test surface automatically and autonomously. The automated system can be provided with a motorized drive mechanism and instructions for traveling across, and collecting sample from, a predetermined area.

FIGS. 13A and 13B illustrate another example of a squeegee collection device 1300 that can be used in hazardous contamination detection kits described herein. FIG. 13A illustrates a top view of the squeegee collection device 1300 and FIG. 13B illustrates a perspective view of the squeegee collection device 1300. The squeegee collection device 1300 includes a handle 1320 and a swab 1315 coupled to one end of the handle. Squeegee collection device 1300 also includes a trailing squeegee 1310 that trails behind the swab 1315 when wiped across a surface in order to collect any liquid not initially picked up by the swab between the squeegee 1310 and swab 1315. Squeegee collection device 1300 also includes a pair of lead directing squeegees 1305 that direct liquid in front of the device 1300 inward (toward a center axis of the device) toward the swab 1315. This can allow for a decreased size of the swab 1315 and trailing squeegee compared to the embodiment of FIG. 12.

Providing at least a trailing squeegee as shown in FIGS. 12 and 13A-13B can improve collection efficiency by collecting liquid that the swab would not ordinarily absorb as it travels over the liquid, thus exposing the swab to the liquid for a longer time and allowing the swab to absorb the excess liquid. Thus, in the embodiments of FIGS. 12 and 13A-13B, the absorbent swab and squeegees can contact different portions of the test surface simultaneously when in use.

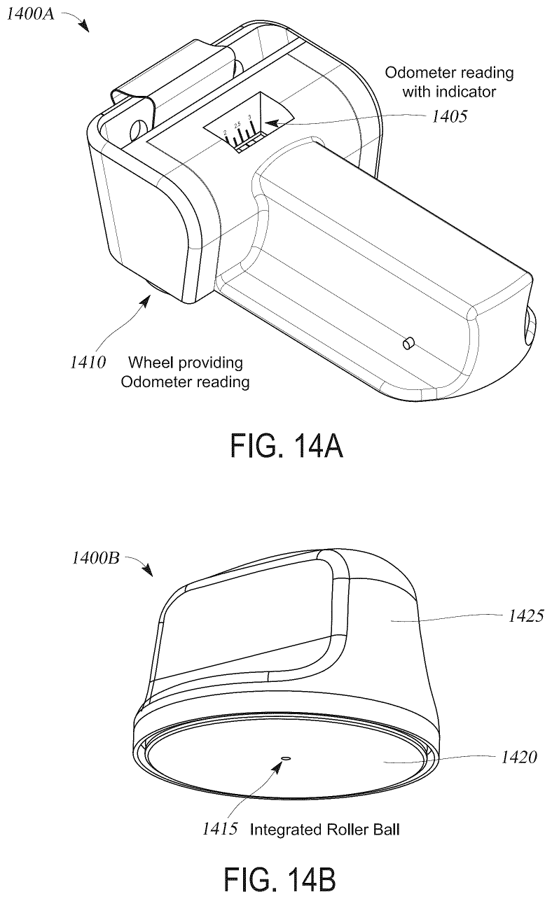

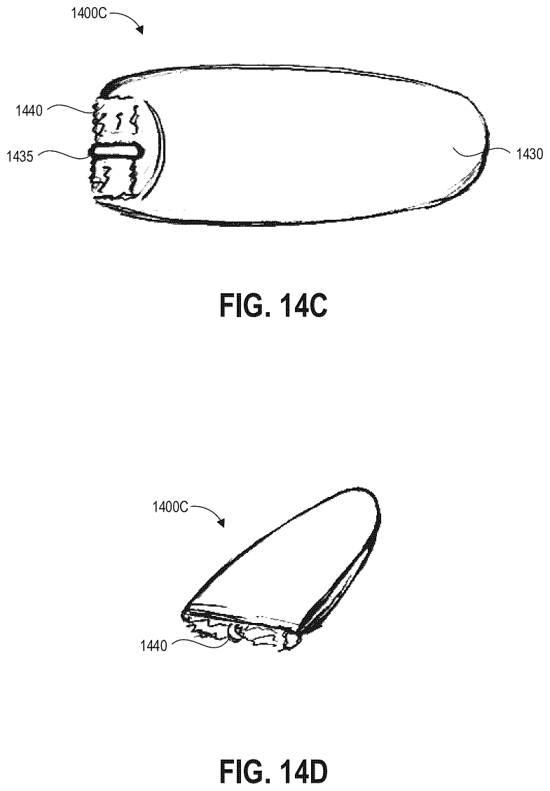

In order to track the area swabbed for more accurate test result calculations, some embodiments of the disclosed collection devices can include an odometer to track the distance that the collection device has traveled. This distance can be displayed to the user and manually entered into a detection device or electronically transmitted from the contaminant collection device to the detection device in various embodiments. FIGS. 14A-14D illustrate various embodiments of a contaminant collection device with a built-in odometer. FIG. 14A illustrates a distance-tracking collection device 1400A that has a wheel 1410 configured to track the distance that the device 1400A travels as it is rolled across a surface, and also includes a display 1405 for providing an odometer reading. FIG. 14B illustrates a distance-tracking collection device 1400B that includes a handle 1425, swab 1420, and a roller ball 1415 integrated into the swab area to provide for tracking of the distance traveled by the swab. Although not illustrated in FIG. 14B, a distance-tracking collection device 1400B can include a display for displaying an odometer reading to the user. FIG. 14C illustrates a top view of a distance-tracking collection device 1400C that includes a handle 1430, a swab 1440, and an integrated roller wheel 1435 centrally located in a swab 1440. FIG. 14D illustrates a front perspective view of the distance-tracking collection device 1400C.

Another embodiment can include a swab provided integrally with an assay test cartridge such that a user can directly capture a sample from a surface using the test cartridge.

### Overview of Example Liquid Removal

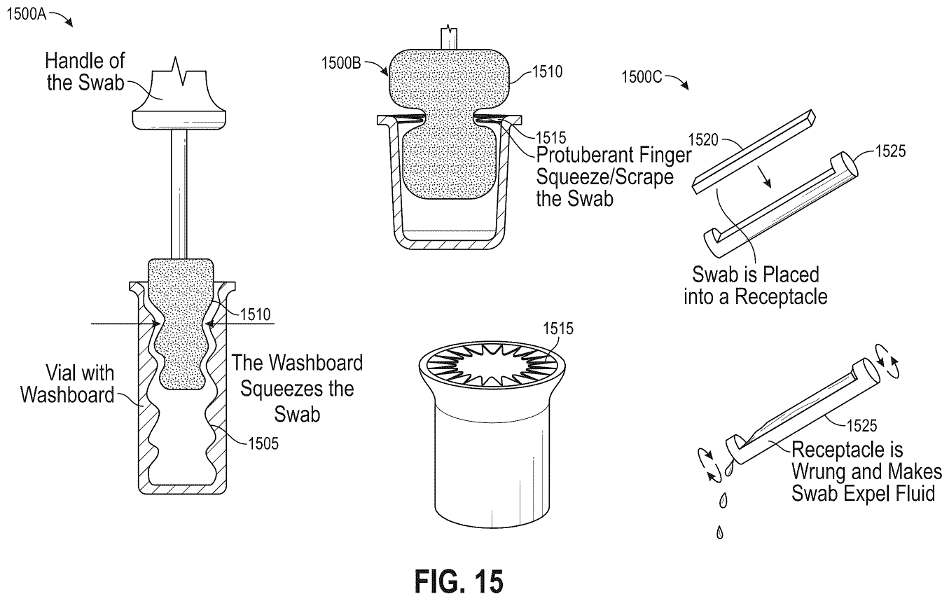

FIG. 15 illustrates various examples of removal of liquid from swabs in contaminant collection devices 1500A, 1500B, and 1500C. One embodiment of a contaminant collection device 1500A can include ridges 1505 along an interior of a container sized such that, when a swab 1510 is inserted into the container, the ridges compress the material of the swab 1510 in order to expel collected liquid from the swab 1510. Another embodiment of a contaminant collection device 1500B can include one or more layers of circumferentially disposed protrusions 1515 at or near an entrance to the interior of the container and/or disposed along the interior sides of the container. The protrusions 1515 can squeeze and scrape the swab 1510 as it is inserted into the container in order to expel collected liquid from the swab 1510. Another embodiment of a contaminant collection device 1500C can include a flexible container 1525 sized to receive a swab 1520 and configured to be wrung, where sides of the swab are rotated in opposing directions, in order to expel liquid from the swab 1520. In some cases, a controlled volume of liquid can be expelled from one end of the flexible container 1525 as the ends are twisted in opposing directions.

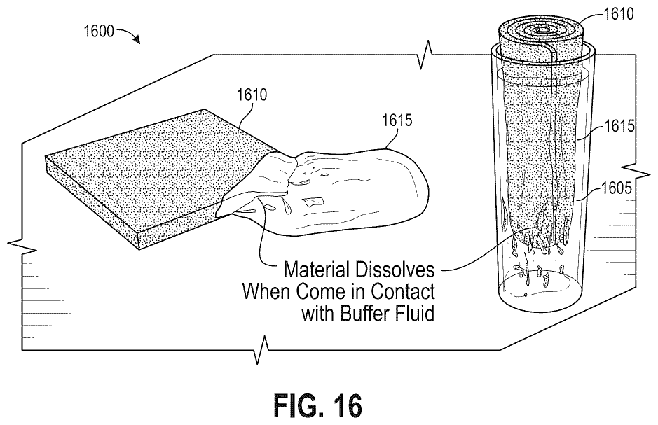

FIG. 16 illustrates an example of a dissolvable swab system 1600 that can be used in hazardous contamination detection kits described herein. In some embodiments, swab 1610 can be constructed from a material that dissolves upon contact, or after prolonged contact, with a liquid. In some embodiments, a first liquid can be provided to the test surface for lifting contaminants off of the surface for pick-up by the swab, and the swab may not dissolve in contact with the first liquid so that the swab can be used to wipe the entire demarcated area. A second liquid 1615 can be contained within container 1605 to dissolve the swab 1610 into the liquid of the container after the swab 1610 is introduced into the container. Dissolving the swab into the liquid in the container can provide the benefits of a more homogenous mixture for testing and of not retaining any contaminant in the swab when the container liquid is transferred to a detection device.

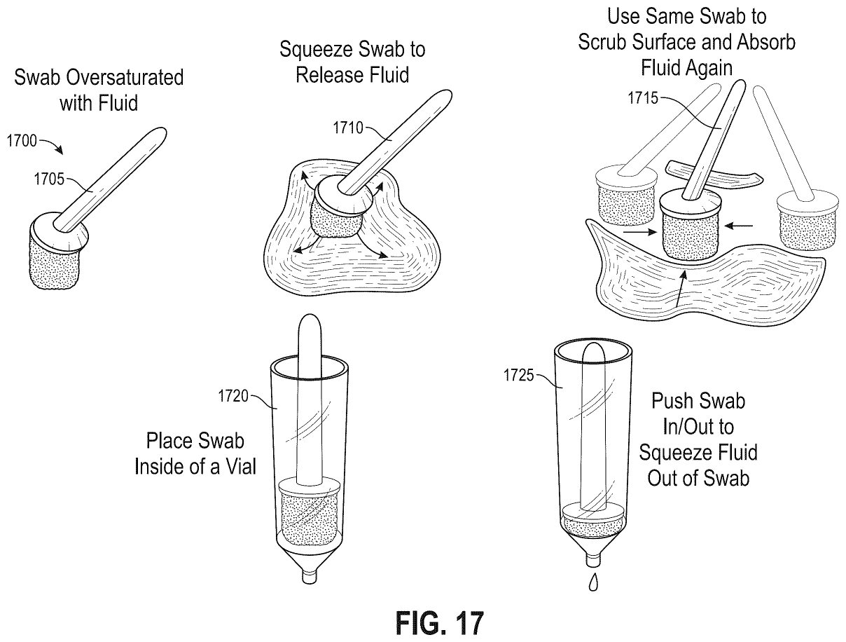

FIG. 17 illustrates example steps for a method 1700 of collecting contaminant from a test surface using an oversaturated collection device swab. The method 1700 can be implemented by any of the contaminant collection devices described herein.

At step 1705, a user can obtain a fully saturated swab attached to a handle, for example by withdrawing the swab from its own packaging or from a pre-filled collection container. Fully saturated as used herein refers to the swab containing a sufficient volume of liquid such that, when compressed, the swab material will release the liquid to a relatively large area (larger than the area directly contacted by the swab) of the test surface. Fully saturated swabs can contain all of a desired volume of liquid such that the liquid does not drip out of the material. In other embodiments a swab that is oversaturated (such that liquid is intended to drip out of the material) can be provided.

At step 1710, the user can squeeze the swab, such as by pressing the swab against the test surface while holding the handle, causing liquid to be expelled from the swab.

At step 1715, after (or as) the liquid is expelled the user can scrub or wipe the surface, passing the swab material over the expelled liquid, until it is completely or almost completely absorbed into the swab again. In some embodiments, steps 1710 and 1715 can be repeated over different areas of a demarcated test surface area until the entire area has been swabbed.

At step 1720, after acquiring the sample from the test surface, the user can place the swab into a vial in order to contain the liquid.

At step 1725, the user can squeeze the swab again by compressing the material into the bottom of the vial, thereby expelling the sample. In some embodiments, the vial can be coupled to a separate collection chamber so that the expelled liquid is stored for testing and not re-absorbed into the swab. The user can subsequently transfer the liquid from the vial or collection chamber to a detection device via any of the open or closed fluid transfer systems described herein.

### Overview of Example Networked Testing Environment

Aspects of the present disclosure relate to a contamination test data management system. There are drug preparation systems, surface contamination tests, and healthcare worker safety procedures in the hospital and other healthcare delivery environments. These three areas are connected only to the extent that they have a common goal: to reduce or eliminate healthcare worker exposure to hazardous drugs, for example noble metal-containing compounds, and to ensure patients are provided correct drug doses. The described hazardous contamination detection kits, systems and techniques improve upon existing approaches by linking these three areas, sensing patterns and trends, and targeting worker feedback and training. By creating and analyzing associations between data regarding dose preparation, personnel activities, and contamination test results, the disclosed systems can provide information to healthcare workers and management targeted at risk identification, feedback, and training. A beneficial outcome can include behavioral and/or workflow changes to reduce exposure risk in the test areas.

There are several existing solutions for assisting with pharmacy (or other clinical setting) drug preparation workflow. Each of these systems is designed to enhance patient safety through automated preparation or verification steps in compounding drugs. These systems are often used with hazardous drugs, such as chemotherapy agents, because there is little room for error with these drugs due to the health risks of exposure to even trace amounts. One such system performs automated dose calculation, weight-based (gravimetric) preparation and verification, integrated drug and consumable barcode verification, real-time automated documentation of the compounding process, and step-by-step compounding guidance. Other examples can employ a camera that captures images of products used in dose preparation and optionally an integrated weighing scale design with step-by-step guidance and automatic documentation.

While these systems help automate several aspects of drug preparation, they do not address pre- and post-preparation issues in the pharmacy, such as managing data associated with surface contamination testing (for example, floors, walls, hoods, etc.). They also do not manage data associated with air testing, nor data from testing individuals via fingertip, urine, blood or any other personal exposure monitoring.

Surface wipe tests are available from companies such as ChemoGLO™ which provide quantitative analysis of the antineoplastic agents 5-fluorouracil, ifosfamide, cyclophosphamide, docetaxel and paclitaxel. An example existing kit contains enough materials to conduct six surface wipes. The wipes and samples are sent to an outside laboratory, and reports are provided back to the test location within three to four weeks. Such tests and delayed reports are disconnected processes from day to day activities in the pharmacy.

Hazardous drugs, particularly noble metal-containing chemotherapy drugs, are known to contaminate surfaces and air in pharmacies and other patient care settings, which presents a significant health risk to pharmacy and other healthcare workers. Further, the United States Pharmacopeia (Cpater 797, 28th Rev) recommends sampling of surfaces for contamination with hazardous drugs at least every six months. With improved testing technology, better feedback and improved outcomes, the frequency of testing is expected to become a more routine activity.

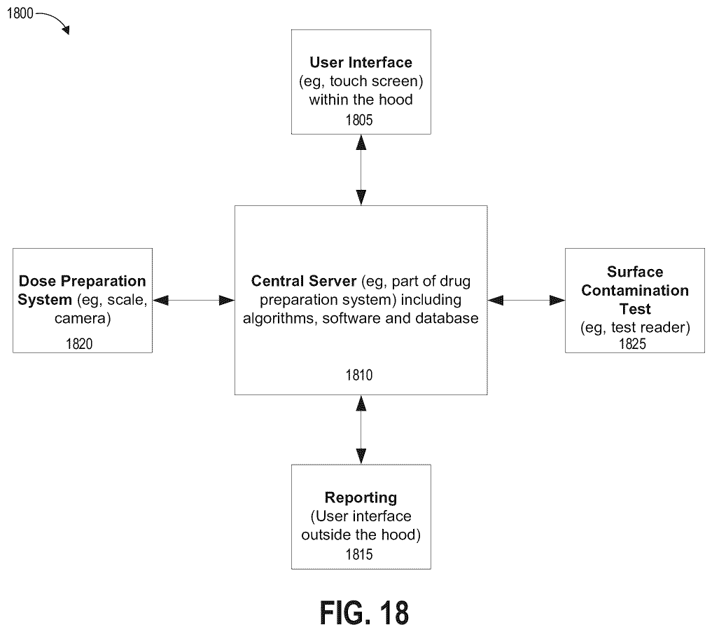

FIG. 18 depicts a high level schematic block diagram of an example networked test system environment 1800. Hazardous contamination detection kits described herein can be used in the networked test system environment 1800 to improve contamination detection, risk identification, feedback, and training. The networked environment 1800 includes a user interface 1805, dose preparation system 1820, surface contamination test 1825, and reporting system 1815 in network communication with a central server 1810 (and/or one another) via a network. The network can be any suitable data transfer network or combination of networks including wired networks and/or wireless networks such as a cellular or other publicly accessible network, WiFi, and the like.

The user interface 1805 supports system interaction by the test operator and can be located in the work area, for example in or near the testing environment. This facilitates interaction without the test operator having to remove and reapply personal safety equipment in order to use the system.

The dose preparation system 1820 can be hardware associated with a gravimetric dose preparation system, a scale, robotics, or devices that are designed to assist in the preparation of safe drug doses for the patient.

The surface contamination test 1825 can include a local test processing system which is in network communication with at least the central server 1810. For example, the local test processing system can be the assay reader device 800 of FIG. 8.

Central server 1810 can implement the algorithms, decisions, rules, and heuristics involved with management of contaminant testing data, and can store data (individual and aggregate), handle data input and/or output, generate reports, provide the user interface, and the like. Though referred to as a central server, these functions could be carried out in a distributed fashion, virtually, in any location.

The reporting user interface 1815 can provide raw and processed data to the user or safety manager regarding the relationship between activities in the pharmacy and test results.

In some implementations, the above descriptions apply to tests that are performed immediately in a pharmacy, hospital, or other clinical setting. However, the described testing is not limited to architectures where instant, immediate, or real-time connectivity is available. For example, if a local wipe test processing system is not available, data from a remote system can be transmitted to the central server using any number of methods. Results from tests may be fed in to an interface manually, electronically encoded, or in machine readable format. Data networks (e.g., internet, wireless, virtual private, cloud-based) can be used to input data from a remote lab (outside the pharmacy, hospital, or clinic) that performs testing either immediately or at a later time. The main difference between immediate local contamination detection versus remote testing is a potential time delay. As described above, current contaminant detection occurs in a two-step process with the steps performed at different locations. First, collection happens at site of possible contamination. Collection occurs a time A. Second, detection of the contamination occurs in a laboratory facility geographically separate from the contamination. Detection occurs at a time B, which is weeks or even months after collection occurred. The present disclosure provides a system including collection device and detection device in one kit. Using the disclosed kit, collection and detection occur at the site of possible contamination, and detection occurs within minutes of collection. For example, collected liquid can be provided onto an assay immediately (for example, within seconds such as but not limited to within 1, 2, 3, 4, 5, 10, or 15 seconds) after agitation of the liquid within a container as described herein. The collected liquid can be provided to the assay for up to 3 hours (360 minutes) after agitation in some embodiments. In some embodiments, instructions for use include a recommendation to the user not to apply the collected liquid to the assay more than 3 hours after collection because accuracy may decrease after 3 hours. After the liquid is added to the assay it can take around five minutes to fully develop in some non-limiting examples. In one advantageous implementation, the assay is read by a detection system around the time of its complete development. As such, the disclosed kits can provide test results indicating the presence, absence, and/or degree of contamination between 2-365 minutes after completion of sample collection, in some embodiments. Laboratory testing of embodiments of test kits described herein has demonstrated that reliable results can be obtained within about 5 minutes of completion of sample collection, and in some cases in as little as 2 minutes of completion of sample collection. This represents a dramatic improvement in the time to obtain a test result indicating the presence, absence, and/or degree of contamination of a hazardous drug over prior systems.

Embodiments of the system 1800 described herein directly link activities performed in the test environment to test results. For example, the system 1800 can directly link contaminant test results to when activities (for example, during antineoplastic drug preparation, dosing, and the like) were performed, who performed these activities (for example, through authentication), where the activities occurred (which hood, nearby floor, air test), and other events (such as spills, wasting of materials, or improper waste disposal) which can be manually or automatically recorded. In some embodiments, the central server 1810 can perform analysis of the related information to identify trends in hazardous contamination levels, and can output recommendations for preventing or mitigating hazardous contamination levels in certain areas.

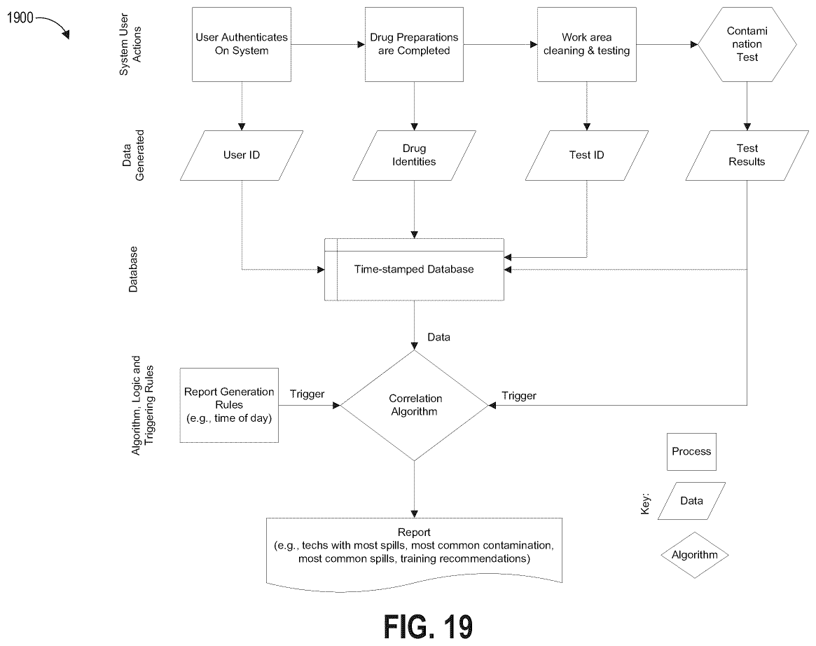

FIG. 19 depicts a flow chart of an example process 1900 for test data generation, analysis, and reporting that can be implemented in some embodiments of the system 1800 of FIG. 18.

The dose preparation system 1820, whether volumetric, gravimetric, photographic, or bar code scanning, can be capable of keeping a record of every dose that was prepared in a particular pharmacy hood or other work area or clinical care area, when the dose was prepared and/or administered, and who prepared and/or administered the dose (for example, the identity of the pharmacy technician). As described above, this information can be correlated with the results of the contamination test.

The correlation algorithm can, in some embodiments, match detected contamination with specific personnel who might have created or contributed to the contamination. For example, if three technicians worked in a hood, and only one worked with compound x, and compound x was identified in a contamination test, then the technician who worked with compound x might be targeted for training or follow up testing.

The correlation algorithm can, in some embodiments, provide contamination test guidance by limiting tests to compounds that were actually used over a period of time, or used since the last contamination test. In a scenario where more than one test is required to screen for multiple possible contaminants, the cost may increase for a number of reasons. For example, it may take a longer period of time to perform testing due to more samples being needed. The time it takes to run a test may be longer. Sample preparation may be more complex. Each test may have an incremental cost, so tailoring tests may lower the overall cost. Advantageously, the dose preparation system could direct the user, or an automated system, to perform only contamination tests for drugs that were prepared in a specific location or hood.

The correlation algorithm can, in some embodiments, improve the specificity of contamination tests by utilizing a priori knowledge of drugs that were prepared in the hood. For example, if a contamination test shows a positive result, but is not capable of indicating which of a family of possible contaminants actually has been identified, the database of drugs prepared in the hood could be queried for all of those possible drugs, and the test result narrowed to the ones actually prepared. In some implementations, further testing can be performed for those specific drugs.

The correlation algorithm can, in some embodiments, determine systematic issues with devices used in preparing drugs. Drug preparation systems can have the capability to store information representing the products and devices used in drug preparation. For example, information on syringe types (manufacturer, volume etc.), closed system transfer devices, connectors, spikes, filters, needles, vials, and IV bags, to name a few examples, can be stored along with the drug and diluent data in the preparation systems database. Failures can be linked to specific devices and directly help with risk mitigation.

The correlation algorithm can, in some embodiments, identify drug manufacturers, dose and containers that systematically fail, resulting in detected contamination. The correlation algorithm can identify procedures that commonly cause contamination, such as reconstitution steps.

The system 1800 can provide some or all of these analytics, alone or in combination, in various embodiments.

The system 1800 can be designed to implement workflows that are initiated based on a set of conditions. For example, one condition that can trigger a workflow is the detection of contamination. Examples of workflows are described below.

A decontamination workflow can include the following procedures. The system 1800 can instruct a user how to contain and decontaminate a specific area, depending on what area the test was performed in. Instructions can include audio, text, video, and the like. After decontamination, the workflow can continue to instructions on performing repeat contamination tests to ensure the area was properly decontaminated. If testing fails again, the decontamination procedure can be repeated.

The system 1800 can be configured to provide instructions through the user interface 1805 and/or dose preparation system 1820 (or any other means of communication, including printed instructions, other displays, voice output and input, direct messages to designated users, etc.). These instructions can be configured to be specific for certain sources of contaminants.

Another example workflow is repeat testing of the area of contamination, prior to decontamination. This may be a useful workflow if the specificity of a particular test is not high. The objective could be to re-test with the same test, or perform further tests to identify more specifically, what the source and/or level of contamination is. A follow-on step could be specific decontamination instructions, already described above.

In various workflows, system 1800 can be configured to receive, prompt, and/or wait for input during the workflow to acknowledge completion of each step. The system 1800 can be configured to capture decontamination procedure evidence, such as photographic, video, audio, proximity information for future review, training, documentation, and the like.

System 1800 can be configured to identify risks from preparation issues. For example, the system 1800 can analyze data already captured by a drug preparation system, or provide means to capture data regarding drug preparation issues, problems or errors. For example, when material is wasted, the user involved can be questioned about whether there was a spill or any surface contamination that caused the wasting. System 1800 can link wasting with positive contamination tests, if wasting is commonly caused by spills.

System 1800 can be adapted for use in non-pharmacy healthcare environments including, but not limited to, hospitals, clinics, hospice environments, and veterinary treatment centers. The system 1800 can be adapted to other areas of patient care, such as the patient floor, nursing, drug delivery (e.g., infusion, injection), patient room, bathroom, etc. Contamination tests can be performed in any of these settings, and this data can be fed back to the system 1800. As described above, detected contamination can be correlated with personnel, protocols followed, specific drugs, devices, locations, and any other parameter of interest. Any parameter around the delivery of drugs that can be encoded can be correlated with the presence of contamination to provide feedback to risk managers, clinical and pharmacy personnel. Further, dose preparation and dispensing can occur in many locations outside the pharmacy, and similar workflows can be employed in those areas, including remote contamination test preparation and execution.

The physical location of specific functions performed by the system 1800 are not restricted to the pharmacy or hospital data center. Any structure or function of the system 1800, including the database, correlation and analysis, data entry, data display, reporting, etc., can be carried out in any system in any location. A system model may be to have a central web-based service, for example. Another model may be to have remote reporting and notification capability through remote devices like smart phones, pagers, computers, displays, applications etc.

Supply of devices can be automated through any of the previously described systems. For example, pharmacies may be provided resupply of test kits by system 1800, and such resupply can be automated in some embodiments by managing an inventory of kits and initiating a resupply when stock falls below a certain level.

### Overview of Example Swab Materials and Liquids

Considerations in the development and selection of swab materials and liquids will not be described. Optimal swab materials and liquids will be identified, but it will be understood that hazardous contamination detection kits described herein can use any suitable swab material and liquid. Three criteria for choosing a swab for use with the described contamination collection devices include the following. (1) Minimal background-Background is the amount of contaminant on a swab measured by the analytical technique after testing has been performed according to the analytical protocol before sampling. Blank contribution from the swab must be minimal. (2) High recovery rate-Recovery means the percentage of contaminant actually measured by the analytical technique when the swab is spiked with a known quantity of that species. In one non-limiting example, a sixty-percent recovery rate is deemed acceptable; however, higher recovery rates are desirable. (3) Low particle generation—It is desirable that the swabbing material leave the swabbed surface free from particles which would further contaminate the surface.

Through extensive testing it has been discovered that cleanroom-laundered, 100 percent continuous-filament, double-knit polyester materials can meet all the requirements for swabbing: minimal background, high recovery rates, and low particle generation. Swabs made with cleanroom-laundered 100 percent polyester-knit heads feature low particle generation and extremely low nonvolatile residues. Thus, some embodiments of the swabs described herein can include one or more layers of such material.

### Implementing Systems and Terminology

Implementations disclosed herein provide systems, methods and apparatus for detection of the presence and/or quantity of antineoplastic agents or other environmental contaminants. One skilled in the art will recognize that these embodiments may be implemented in hardware or a combination of hardware and software and/or firmware.

The assay reader device may include one or more image sensors, one or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The device may additionally include a transmitter and a receiver. The transmitter and receiver may be jointly referred to as a transceiver. The transceiver may be coupled to one or more antennas for transmitting and/or receiving wireless signals.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling.” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. The phrase “based on” does not mean “based only on,” unless expressly specified otherwise. In other words, the phrase “based on” describes both “based only on” and “based at least on.”

The previous description of the disclosed implementations is provided to enable any person skilled in the art to make or use the present invention. Various modifications to these implementations will be readily apparent to those skilled in the art, and the generic principles defined herein may be applied to other implementations without departing from the scope of the invention. Thus, the present invention is not intended to be limited to the implementations shown herein but is to be accorded the widest scope consistent with the principles and novel features disclosed herein.

The methods described herein are further illustrated by the following examples.

### Example 1

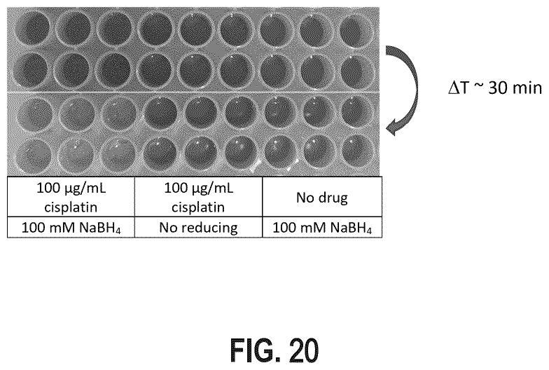

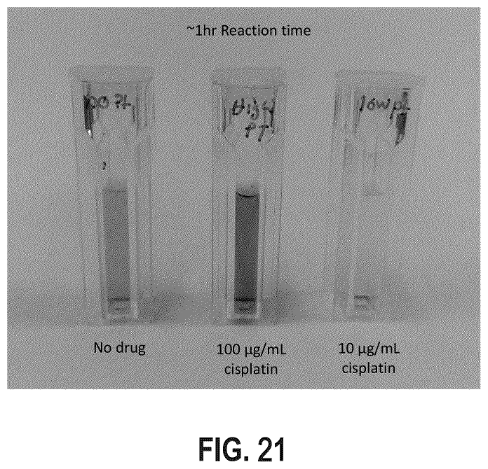

The current example shows Congo Red reduction in a well plate format. A solution Congo Red in 0.9% saline was prepared and dispensed into a well plate. To the Congo Red solutions was added either (a) 100 μg/mL cisplatin and 100 mM sodium borohydride; (b) 100 μg/mL cisplatin and no reducing agent; or (c) no drug and 100 mM sodium borohydride. After 30 minutes, clarification is observed in wells containing reducing agent as comparted to those containing no reducing agent with drug or no drug with reducing agent. The results are shown in FIG. 20.

### Example 2

The current example shows Congo Red reduction in a cuvette format. A solution Congo Red in 0.9% saline was prepared and dispensed into a well plate. To the Congo Red solutions was added either (a) no drug; (b) 100 μg/mL cisplatin and sodium borohydride; or (c) 100 μg/mL cisplatin and sodium borohydride. After one hour, visible precipitation forms at high cisplatin levels (100 μg/mL), while discoloration is observed at somewhat lower cisplatin levels (10 μg/mL). The results are shown in FIG. 21. Accordingly, this method demonstrates a relatively fast visibly detectable reaction.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for detecting noble metal-containing compound contamination of a surface, the method comprising:
collecting a sample comprising a noble metal-containing compound from said surface;
contacting said sample with a dye and a reducing agent to form a test solution; and
measuring an absorbance of the test solution.

2. The method of claim 1, wherein the method further comprises measuring the rate of absorbance change.

3. The method of claim 1, wherein the dye is an azo dye.

4. The method of claim 1, wherein the dye is Congo red or methyl orange.

5. The method of claim 1, wherein the dye is methylene blue.

6. The method of claim 1, wherein the reducing agent is selected from the group consisting of: lithium borohydride, lithium aminoborohydride, sodium borohydride, and sodium cyanoborohydride.

7. (canceled)

8. The method of claim 1, wherein the noble metal is selected from the group consisting of ruthenium, rhodium, palladium, platinum, silver, gold, osmium, and iridium.

9. (canceled)

10. The method of claim 8, wherein the noble metal-containing compound is selected from the group consisting of: cisplatin, oxaliplatin, nedaplatin, carboplatin, triplatin tetranitrate, phenanthriplatin, picoplatin, and satraplatin.

11. (canceled)

12. (canceled)

13. The method of claim 8, wherein the noble metal-containing compound is sodium trans-imidazoledimethylsulfoxidetetrachlororuthenate(III), imidazolium trans-imidazoledimethylsulfoxidetetrachlororuthenate(III), or sodium trans-[tetrachloridobis(1H-indazole)ruthenate(III)].

14. (canceled)

15. The method of claim 8, wherein the noble metal-containing compound is selected from the group consisting of: gold sodium thiosulfate, gold sodium thiomalate, disodium aurothiomalate, aurothioglucose, and auranofin.

16. The method of claim 1, wherein the absorbance is measured at 490 nm to 510 nm, 460 nm to 480 nm, or 660 nm to 680 nm.

17. (canceled)

18. (canceled)

19. A noble metal-containing compound contamination detection system comprising:
a collection device comprising:
a liquid configured to lift a noble metal-containing compound contaminant from a test surface when the liquid is applied to the test surface,
an absorbent swab material configured to absorb at least a portion of the liquid and to contact the test surface to collect the noble metal-containing compound contaminant,
a handle having a first end coupled to the absorbent swab material, a second end spaced apart from the first end, and an elongate length extending therebetween,
a liquid-tight container having an interior volume dimensioned to encase the handle and the absorbent swab material and the liquid, the container having a nozzle including an orifice sized to provide controlled release of a volume of the liquid from the interior volume; and
a detection device comprising:
a test cartridge positioned to receive the volume of the liquid released from the container, the test cartridge comprising a dye and a reducing agent to produce an optically-detectable change in appearance in the presence of the noble metal-containing compound contaminant, and
an image sensor positioned to receive light reflected from the test cartridge and configured to generate signals representing an intensity of the received light, and
control electronics configured to analyze the signals and determine the presence of the noble metal-containing compound contaminant in the test cartridge.

20-25. (canceled)

26. A noble metal-containing compound contaminant collection device comprising:
a liquid-tight container having an interior volume and containing a dye and a reducing agent;
a liquid configured to lift a hazardous noble metal-containing compound contaminant from a test surface when applied to the test surface;
an absorbent swab material configured to absorb at least some of the liquid and to contact the test surface to collect the hazardous noble metal-containing compound contaminant; and
a handle having a first end coupled to the absorbent swab material, a second end spaced apart from the first end, and an elongate length extending therebetween, wherein the interior volume is dimensioned to contain the handle and absorbent swab material and the at least some of the liquid, the container having a nozzle including an orifice sized to provide controlled release of a volume of the liquid from the interior volume.

27-34. (canceled)

35. A method of testing a test surface for the presence of a hazardous noble metal-containing compound contaminant, the method comprising:
removing an absorbent swab material coupled to an elongate handle from liquid-tight packaging, the absorbent swab material pre-moistened with a first volume of a liquid configured to lift the hazardous contaminant from the test surface, wherein the absorbent swab material is impregnated with the first volume of the liquid;
wiping the test surface with the absorbent swab material to collect particles of the hazardous contaminant from the test surface;
inserting the absorbent swab material into an open end of a liquid-tight container, the liquid-tight container comprising a well containing a second volume of the liquid and a cap to seal the well;
sealing the liquid-tight container with the cap to isolate the first and second volumes of the liquid within the liquid-tight container;
agitating the liquid-tight container to release at least some of the collected particles of the hazardous contaminant into the liquid;
opening a sealable orifice of the cap;
transferring a third volume of the liquid from the liquid-tight container to a cartridge comprising a dye and a reducing agent through the sealable orifice;
inserting the cartridge into a cartridge reader device; and
based on an output of the cartridge reader device, identifying that the noble metal-containing compound contaminant is present on the test surface.
